(19) United States
(12) Patent Application Publication
(10) Pub. No.: US 2019/0171153 A1
(43) Pub. Date: Jun. 6, 2019

(54) IMAGE FORMING APPARATUS

(71) Applicant: CANON KABUSHIKI KAISHA, Tokyo (JP)

(72) Inventors: Hideki Ohta, Numazu-shi (JP); Kazushi Suzuki, Suntou-gun (JP); Yoshitaka Zaitsu, Suntou-gun (JP)

(21) Appl. No.: 16/259,370

(22) Filed: Jan. 28, 2019

Related U.S. Application Data
(63) Continuation of application No. PCT/JP2017/026772, filed on Jul. 25, 2017.

(30) Foreign Application Priority Data
Jul. 29, 2016 (JP) 2016-149388
Jul. 29, 2016 (JP) 2016-150420
Jul. 29, 2016 (JP) 2016-150421

(51) Int. Cl. G03G 15/00; G03G 15/20; B65H 5/06; B65H 29/60; G03G 15/23

(52) U.S. Cl. CPC G03G 15/6529; G03G 15/2028; G03G 15/6558; B65H 1/04; B65H 5/068; B65H 29/60; G03G 15/234; G03G 15/6502

(57) ABSTRACT

A sensor unit is at least partially disposed in a region below an upper end of a reversing roller, above a lower end of a second rotary member, and outside a duplex conveying path.

### CROSS-REFERENCE TO RELATED APPLICATIONS

This application is a Continuation of International Patent Application No. PCT/JP2017/026772, filed Jul. 25, 2017, which claims the benefit of Japanese Patent Application Nos. 2016-149388, 2016-150420, and 2016-150421 filed Jul. 29, 2016, all of which are hereby incorporated by reference herein in their entirety.

### TECHNICAL FIELD

The present invention relates to an electrophotographic image forming apparatus, such as a copier or a laser beam printer, which has the capability of forming images on recording materials, and particularly relates to an image forming apparatus which also has the capability of reading documents.

### BACKGROUND ART

An image forming apparatus, such as a copier or a multifunction printer (MFP), includes a document reading unit in the upper part thereof. Exemplary types of document reading include reading a document, such as a book, placed on a transparent document table, and reading a sheet-like document which is being conveyed with respect to a fixed reading sensor. Some document reading units support only one of the types described above, and others support both of the types described above.

MFPs often have a configuration in which a paper output tray is on the upper surface of a printer main body. Such an MFP has space left above the paper output tray to allow the user to easily access a recording material discharged onto the paper output tray. The document reading unit is disposed above this space. This increases the overall height of the apparatus including the printer main body and the document reading unit.

As a document reading unit, an image forming apparatus described in PTL 1 includes an automatic document feeder (ADF) for conveying a document, but does not include a document table. An image sensor that reads a document is disposed inside a printer main body. This image forming apparatus has no capability of reading a document, such as a book, because of the absence of a document table, but is advantageous in that it has lower overall height.

### CITATION LIST

### Patent Literature

PTL 1 Japanese Patent Laid-Open No. 2014-215431

In the image forming apparatus described in PTL 1, the image sensor is disposed adjacent to a duplex conveying path in the printer main body. In the printer, the duplex conveying path, which also serves as a conveying path for feeding a document and conveying it to the image sensor, is disposed inside the image sensor, and another conveying path for guiding a read document to a document discharge portion is disposed outside the image sensor. As a result, even a single function printer (SFP) with no capability of reading a document requires many conveying paths, and this leads to an increased size of the apparatus.

An object of the present invention is to provide an image forming apparatus that is compact but includes, in a printer main body, a sensor unit capable of reading an image on a document.

### SUMMARY OF INVENTION

To solve the problem described above, the present invention provides an image forming apparatus that includes an image forming unit configured to form an unfixed image on a recording material; a fixing unit including a first rotary member configured to come into contact with the unfixed image on the recording material and a second rotary member configured to form a fixing nip with the first rotary member to convey the recording material therebetween, the fixing unit being configured to fix the unfixed image formed by the image forming unit onto the recording material; a reversing roller configured to reverse the recording material in such a manner that instead of a leading edge, a trailing edge of the recording material that has passed through the fixing unit is conveyed; a duplex conveying path configured to convey the reversed recording material to the image forming unit again; a discharge portion configured to discharge the recording material out of the image forming apparatus; and a sensor unit including a sensor that reads an image on a document. In the image forming apparatus, the sensor unit is at least partially disposed in a region below an upper end of the reversing roller, above a lower end of the second rotary member, and outside the duplex conveying path.

The present invention also provides an image forming apparatus that includes an image forming unit configured to form an unfixed image on a recording material; a fixing unit including a first rotary member configured to come into contact with the unfixed image on the recording material and a second rotary member configured to form a fixing nip with the first rotary member, the fixing unit being configured to fix the unfixed image on the recording material; a reversing portion configured to reverse the recording material in such a manner that instead of a leading edge, a trailing edge of the recording material that has passed through the fixing unit is conveyed; a duplex conveying path configured to convey the recording material reversed by the reversing portion to the image forming unit again; a document feeding portion configured to feed a document; a document discharge portion configured to discharge the document; a document conveying path configured to connect the document feeding portion to the document discharge portion; and a reading unit including a sensor that reads an image. In the image forming apparatus, the duplex conveying path is partially a common conveying path shared with the document conveying path; the reading unit is disposed on a side of the common conveying path facing one of two surfaces of the recording material reversed by the reversing portion, the one being a surface that has more recently come into contact with the first rotary member; and the reading unit has a capability of reading a fixed image on the recording material and an image on the document.

The present invention also provides an image forming apparatus that includes an image forming unit configured to form an unfixed image on a recording material; a fixing unit configured to fix the unfixed image on the recording material; a reversing portion configured to reverse the recording material in such a manner that instead of a leading edge, a trailing edge of the recording material that has passed through the fixing unit is conveyed; a duplex conveying path configured to convey the recording material reversed by the reversing portion to the image forming unit again; a document feeding portion configured to feed a document; a document discharge portion configured to discharge the document; a document conveying path configured to connect the document feeding portion to the document discharge portion; a reading unit disposed in the document conveying path and including a sensor that reads an image on the document; and two conveying paths, one being configured to connect the reversing portion to the document conveying path and the other being configured to connect the document conveying path to the duplex conveying path. In the image forming apparatus, the reading unit has a capability of reading a fixed image on the recording material and an image on the document.

The present invention also provides an image forming apparatus that includes an image forming unit configured to form an unfixed image on a recording material; a fixing unit configured to fix the unfixed image on the recording material; a reversing portion configured to reverse the recording material in such a manner that instead of a leading edge, a trailing edge of the recording material that has passed through the fixing unit is conveyed; a duplex conveying path configured to convey the recording material reversed by the reversing portion to the image forming unit again; a document feeding portion configured to feed a document; a document discharge portion configured to discharge the document; a document conveying path configured to connect the document feeding portion to the document discharge portion; a reading unit disposed in the document conveying path and including a sensor that reads an image on the document; and a conveying path configured to guide the recording material that has passed through the fixing unit to the document discharge portion. In the image forming apparatus, the reading unit has a capability of reading a fixed image on the recording material and an image on the document.

The present invention also provides an image forming apparatus that includes an image forming unit configured to form an unfixed image on a recording material; a fixing unit configured to fix the unfixed image on the recording material; a discharge portion configured to discharge the recording material having the fixed image thereon out of the image forming apparatus; a discharge conveying path configured to guide the recording material from the fixing unit to the discharge portion; a reversing portion configured to reverse the recording material in such a manner that instead of a leading edge, a trailing edge of the recording material that has passed through the fixing unit is conveyed; a duplex conveying path configured to guide the recording material reversed by the reversing portion to the image forming unit again; a first conveying path configured to guide the recording material from a branch point in the discharge conveying path to the reversing portion; a second conveying path configured to guide the recording material reversed by the reversing portion to the duplex conveying path; a reading unit configured to read an image formed on the recording material; a third conveying path configured to guide the recording material reversed by the reversing portion to the reading unit; and a fourth conveying path configured to guide the recording material that has passed through the reading unit to the duplex conveying path. In the image forming apparatus, a front and back orientation of the recording material coming from the reversing portion and passing through the third conveying path, the reading unit, the fourth conveying path, and the duplex conveying path is the same as a front and back orientation of the recording material coming from the reversing portion and passing through the second conveying path and the duplex conveying path, the front and back orientation being an orientation of a front surface on which an image is formed first and a back surface opposite the front surface; and the second conveying path is disposed between the reading unit and the fixing unit.

The present invention also provides an image forming apparatus that includes an image forming unit configured to form an unfixed image on a recording material; a fixing unit configured to fix the unfixed image on the recording material; a discharge reversing portion configured to be able to selectively discharge the recording material having the fixed image thereon out of the image forming apparatus and reverse the recording material in such a manner that instead of a leading edge, a trailing edge of the recording material that has passed through the fixing unit is conveyed; a duplex conveying path configured to guide the recording material reversed by the discharge reversing portion to the image forming unit again; a first conveying path configured to guide the recording material from the fixing unit to the discharge reversing portion; a second conveying path configured to guide the recording material reversed by the discharge reversing portion to the duplex conveying path; a reading unit configured to read an image formed on the recording material; a third conveying path configured to guide the recording material reversed by the discharge reversing portion to the reading unit; and a fourth conveying path configured to guide the recording material that has passed through the reading unit to the duplex conveying path. In the image forming apparatus, a front and back orientation of the recording material coming from the discharge reversing portion and passing through the third conveying path, the reading unit, the fourth conveying path, and the duplex conveying path is the same as a front and back orientation of the recording material coming from the discharge reversing portion and passing through the second conveying path and the duplex conveying path, the front and back orientation being an orientation of a front surface on which an image is formed first and a back surface opposite the front surface; and the second conveying path is disposed between the reading unit and the fixing unit.

Further features of the present invention will become apparent from the following description of exemplary embodiments with reference to the attached drawings.

### BRIEF DESCRIPTION OF DRAWINGS

FIG. 1 is a cross-sectional view of an image forming apparatus.

FIG. 2A is a partial enlarged view of FIG. 1.

FIG. 2B is a partial enlarged view of FIG. 2A.

FIG. 3 is a cross-sectional view of a sensor unit.

FIG. 4 is a perspective view of the sensor unit.

FIG. 5 is a partial enlarged view of an image forming apparatus according to a second embodiment.

FIG. 6 is a partial enlarged view of an image forming apparatus according to a third embodiment.

FIG. 7 is a cross-sectional view of a sensor unit mounted in the image forming apparatus according to the third embodiment.

FIG. 8 is a cross-sectional view of an image forming apparatus according to a fourth embodiment.

FIG. 9 is a cross-sectional view of an image reading unit 100 according to the fourth embodiment.

FIG. 10 illustrates how a recording material flows during printing.

FIG. 11 illustrates how a document flows during reading of an image on the document.

FIG. 12 illustrates how a recording material flows during duplex printing and reading of a printed image.

FIG. 13 is an enlarged cross-sectional view of the image reading unit 100 according to a fifth embodiment.

FIG. 14 is an enlarged cross-sectional view of the image reading unit 100 according to a sixth embodiment.

FIG. 15 is an enlarged cross-sectional view of the image reading unit 100 according to a seventh embodiment.

FIG. 16 is an enlarged cross-sectional view of the image reading unit 100 according to an eighth embodiment.

FIG. 17 is an enlarged cross-sectional view of the image reading unit 100 according to a ninth embodiment.

FIG. 18 is an enlarged cross-sectional view of the image reading unit 100 according to a tenth embodiment.

FIG. 19 is a cross-sectional view of an image forming apparatus according to an eleventh embodiment.

FIG. 20 is an enlarged view of an upper right portion of FIG. 19.

FIG. 21 is a cross-sectional view of an image forming apparatus according to a twelfth embodiment.

FIG. 22 is an enlarged view of an upper right portion of FIG. 21.

FIG. 23 is a cross-sectional view of an image forming apparatus according to a thirteen embodiment.

FIG. 24 is an enlarged view of an upper right portion of FIG. 23.

FIG. 25 illustrates an operation of a conveyance sensor.

### DESCRIPTION OF EMBODIMENTS

### First Embodiment

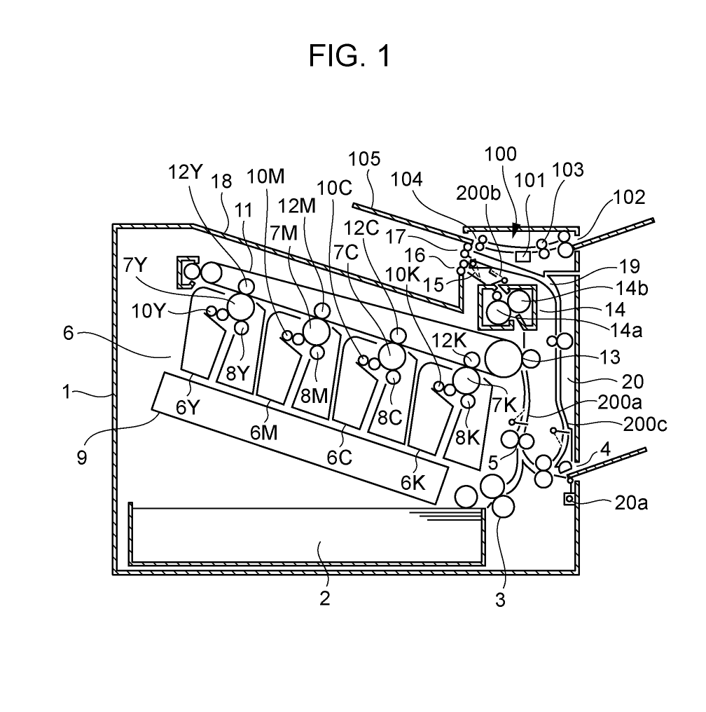

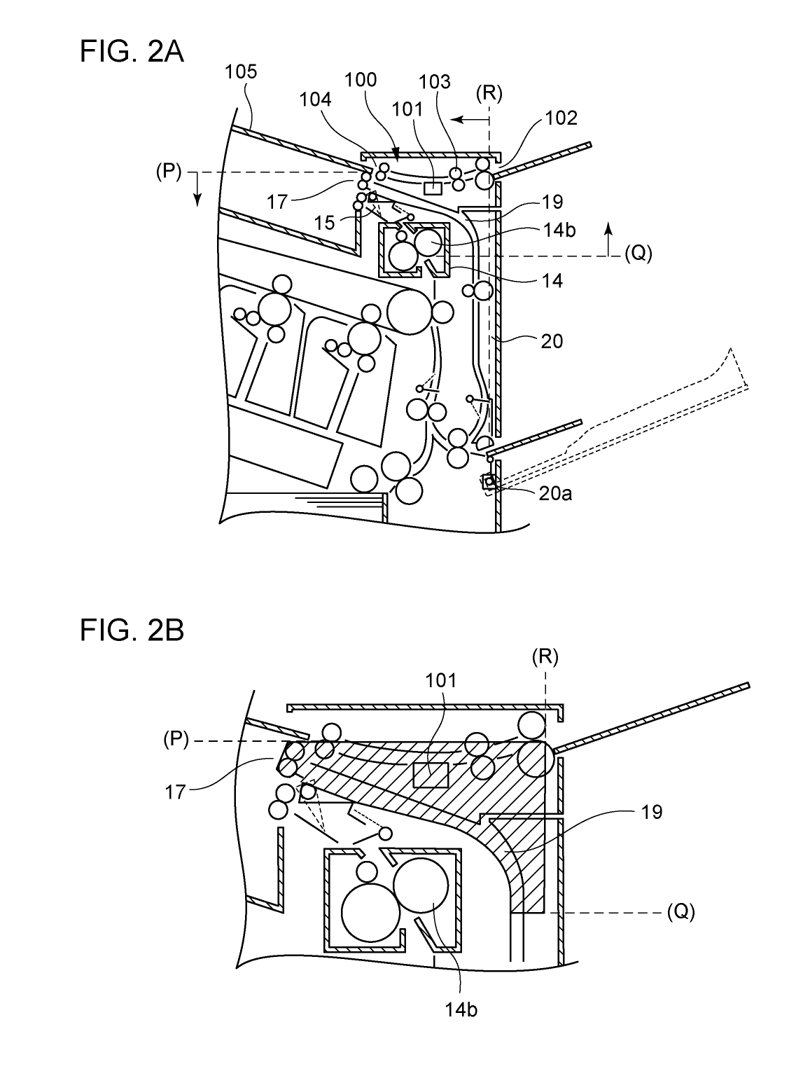

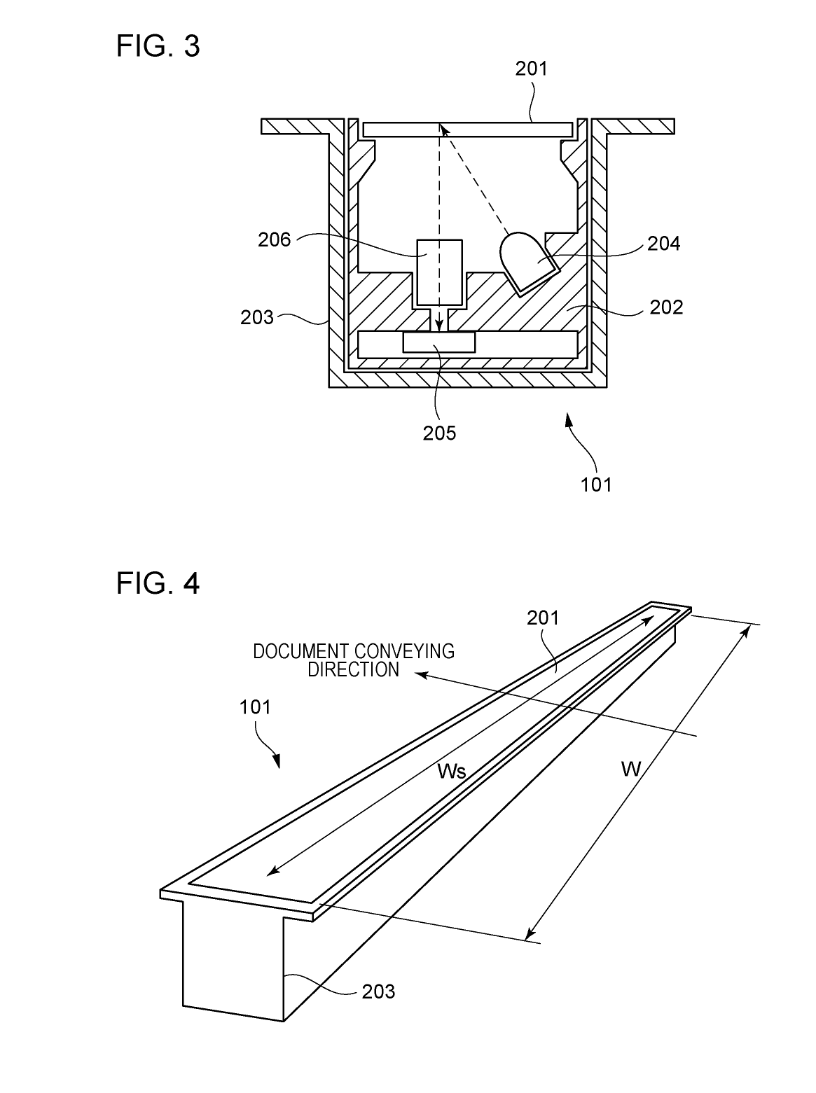

An image forming apparatus according to a first embodiment of the present invention will now be described using FIGS. 1 to 4. FIG. 2A is a partial enlarged view of FIG. 1. FIG. 2B is an enlarged view of FIG. 2A. FIGS. 3 and 4 are explanatory diagrams of a sensor unit. The image forming apparatus according to the first embodiment and second and third embodiments (described below) is a full-color laser beam printer including a plurality of photosensitive drums. The present invention is also applicable to a monochrome image forming apparatus including only one photosensitive drum.

(Feeding Unit)

FIG. 1 is a cross-sectional view of an image forming apparatus 1. A cassette 2 that holds recording materials therein is mounted at the bottom of the image forming apparatus 1 in such a manner that it can be pulled out. A cassette feeding portion 3 is disposed near an end portion of the cassette 2. A manual feeding portion 4 is disposed on the right-hand side of the image forming apparatus 1. The cassette feeding portion 3 and the manual feeding portion 4 are both configured to feed recording materials one by one to registration rollers 5. A conveyance sensor 200a that detects passage of a recording material is disposed downstream of the registration rollers 5 in a recording-material conveying direction.

(Image Forming Unit and Fixing Unit)

The image forming apparatus 1 includes an image forming unit 6. The image forming unit 6 of the present embodiment includes four image forming stations 6Y, 6M, 6C, and 6K of yellow, magenta, cyan, and black. The image forming unit 6 also includes photosensitive members 7Y, 7M, 7C, and 7K each serving as an image bearing member, and chargers 8Y, 8M, 8C, and 8K each configured to uniformly charge the surface of a corresponding one of the photosensitive members 7Y, 7M, 7C, and 7K. The image forming unit 6 further includes a scanner unit 9 that emits laser beams on the basis of image information to form electrostatic latent images on the photosensitive members 7Y, 7M, 7C, and 7K, and developing units 10Y, 10M, 10C, and 10K that cause toners to adhere to the electrostatic latent images to develop the electrostatic latent images. The image forming unit 6 further includes primary transfer portions 12Y, 12M, 12C, and 12K that transfer the toner images on the photosensitive members 7Y, 7M, 7C, and 7K to an electrostatic transfer belt 11. The toner images on the electrostatic transfer belt 11 are transferred onto a recording material at a secondary transfer portion 13. The resulting toner image on the recording material is fixed by a fixing unit 14. The fixing unit 14 includes a fixing roller (first rotary member) 14a that has an internal heat source therein, and a pressure roller (second rotary member) 14b that forms a fixing nip with the fixing roller 14a to convey the recording material therebetween. The recording material is heated at the fixing nip while being conveyed. An unfixed image on the recording material is thus fixed to the recording material.

(Discharge Portion and Reversing Portion)

A conveyance sensor 200b is disposed downstream of the fixing unit 14. When the conveyance sensor 200b is pushed up by the recording material to the position indicated by dotted line in the drawing, the conveyance sensor 200b determines that the recording material is being properly conveyed. Then, if a flapper 15 is at the position indicated by solid line in the drawing, the recording material is guided to a discharge roller pair (discharge portion) 16 disposed to the upper left of the fixing unit 14. If the flapper 15 is at the position indicated by broken line in the drawing, the recording material is guided to a switchback roller pair (reversing rollers, reversing portion) 17 disposed above the discharge roller pair 16. The switchback roller pair 17 is a roller pair that reverses the recording material in such a manner that instead of the leading edge, the trailing edge of the recording material that has passed through the fixing unit 14 is conveyed. The recording material conveyed to the discharge roller pair 16 is discharged out of the apparatus, or more specifically, onto a recording-material supporting portion (recording-material discharge tray) 18.

(Duplex Conveying Unit)

The recording material conveyed to the switchback roller pair 17 is reversed by the switchback roller pair 17 and conveyed to a duplex conveying path (discharge conveying path) 19. The duplex conveying path 19 first extends from the switchback roller pair 17 toward the lower right in the drawing. Next, the duplex conveying path 19 is curved to avoid the fixing unit 14, and then extends toward the bottom of the image forming apparatus 1. As illustrated in FIG. 2A, an opening and closing member 20 that allows the duplex conveying path 19 to be exposed is disposed on the right-hand side of the image forming apparatus 1. The opening and closing member 20 pivots about a hinge 20a of the image forming apparatus 1. When the opening and closing member 20 is closed as indicated by solid line, the inner surface of the opening and closing member 20 also serves as the discharge conveying path 19. To allow the duplex conveying path 19 to be exposed, the opening and closing member 20 is opened to the position indicated by dotted line. A conveyance sensor 200c (see FIG. 1) is disposed in the duplex conveying path 19. When the conveyance sensor 200c is pushed down by the recording material to the position indicated by dotted line, the conveyance sensor 200c determines that the recording material is being properly conveyed. The recording material that has passed through the duplex conveying path 19 is guided to the registration rollers 5 again, passed through the secondary transfer portion 13 and the fixing unit 14, conveyed to the discharge roller pair 16, and discharged onto the recording-material supporting portion 18.

(Image Reading Unit)

An image reading unit 100 that reads an image on a document will now be described. The image reading unit 100 is disposed inside the image forming apparatus 1 and located above the fixing unit 14. The image reading unit 100 includes a sensor unit (image sensor) 101 that reads an image on a document, a document feeding portion 102, registration rollers 103, and a document discharge roller pair (document discharge portion) 104. Documents placed at the document feeding portion 102 are conveyed one by one to the registration rollers 103. While the document is being conveyed from the registration rollers 103, an image on the document is read by the sensor unit 101. After the image is read, the document is discharged by the document discharge roller pair 104 to a document supporting portion 105. Image data read by the sensor unit 101 is either stored as electronic data in a computer on a network, or converted to print data by a control unit (not shown). By using this image data, the image forming unit 6 forms an image on the recording material.

FIGS. 3 and 4 are a cross-sectional view and a perspective view, respectively, of the sensor unit 101. As illustrated in FIG. 3, the sensor unit 101 includes a reading surface 201 made of a transparent material, such as glass, a holder 202, a housing 203, a light-emitting diode (LED) array 204 with LEDs arranged in a sheet width direction, a photodetector 205, and a rod lens 206. The holder 202 is a resin component that holds the LED array 204, the photodetector 205, and the rod lens 206. The housing 203 is made of aluminum. The document is conveyed with the read surface thereof being in contact with the reading surface 201. As illustrated in FIG. 4, the reading surface 201 is longer than a width Ws of a maximum-size document that can be conveyed by the image reading unit 100 (W>Ws). Light emitted from the LED array 204 is reflected off the document surface and converged by the rod lens 206 onto the photodetector 205. By converting the received light into voltage, the photodetector 205 converts document surface information into an electric signal to generate image data.

(Layout of Sensor Unit 101)

The layout of the sensor unit 101 in the image forming apparatus 1 will now be described in detail. As described above, the duplex conveying path 19 is formed in such a manner as to avoid the fixing unit 14, particularly the pressure roller 14b. Therefore, an area which serves no function in an SFP is created in a region below a horizontal plane (P) defined by the upper end of the reversing rollers 17, above a horizontal plane (Q) defined by the lower end of the pressure roller 14b, and outside the duplex conveying path 19. Specifically, this is the region diagonally shaded in FIG. 2B. This diagonally shaded region in FIG. 2B is also surrounded by a vertical plane (R) defined by the hinge 20a (about which the opening and closing member 20 pivots). In the image forming apparatus 1 of the present embodiment, the image reading unit 100 is positioned in such a manner that the sensor unit 101 is at least partially disposed in this diagonally shaded region.

With this layout, an image forming apparatus can be provided, which is compact even though it includes the image reading unit 100 therein. Moreover, since all reading functions are gathered in the space above the image forming unit 6, the functional separation achieved as a result can provide good usability.

### Second Embodiment

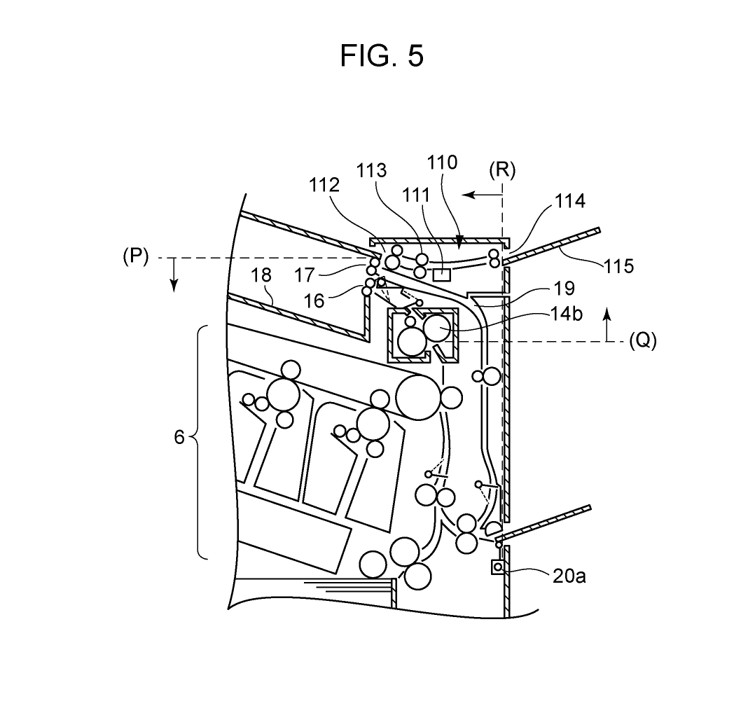

A second embodiment will now be described using FIG. 5. The description of the same components as those of the first embodiment will be omitted. FIG. 5 is an enlarged view of an image reading unit 110 according to the present embodiment. A sensor unit 111 has the same configuration as the sensor unit 101 of the first embodiment. In the present embodiment, a document feeding portion 112 is disposed closer to the reversing rollers 17 than the sensor unit 111 is. This means that a document is conveyed from left to right in FIG. 5. In addition to the sensor unit 111 and the document feeding portion 112, the image reading unit 110 includes registration rollers 113 and a document discharge roller pair 114.

As in the first embodiment, the sensor unit 111 of the present embodiment is at least partially disposed in the region below the horizontal plane (P) defined by the upper end of the reversing rollers 17, above the horizontal plane (Q) defined by the lower end of the pressure roller 14b, and outside the duplex conveying path 19.

In the present embodiment, the recording-material discharge tray 18 onto which a recording material with an image formed thereon by the image forming unit 6 is discharged and a document supporting portion (document discharge tray) 115 onto which a document read by the image reading unit 110 is discharged are disposed at different positions in the horizontal direction. Additionally, a direction in which a recording material with an image formed thereon by the image forming unit 6 is discharged from the discharge roller pair 16 is opposite a direction in which a document is discharged from the document discharge roller pair 114. This can prevent the user from confusing the document with the recording material and provide better usability.

### Third Embodiment

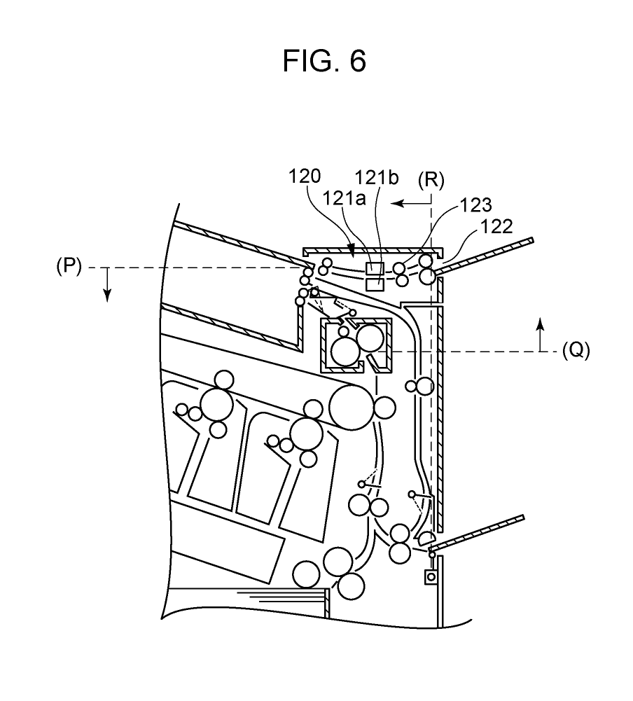

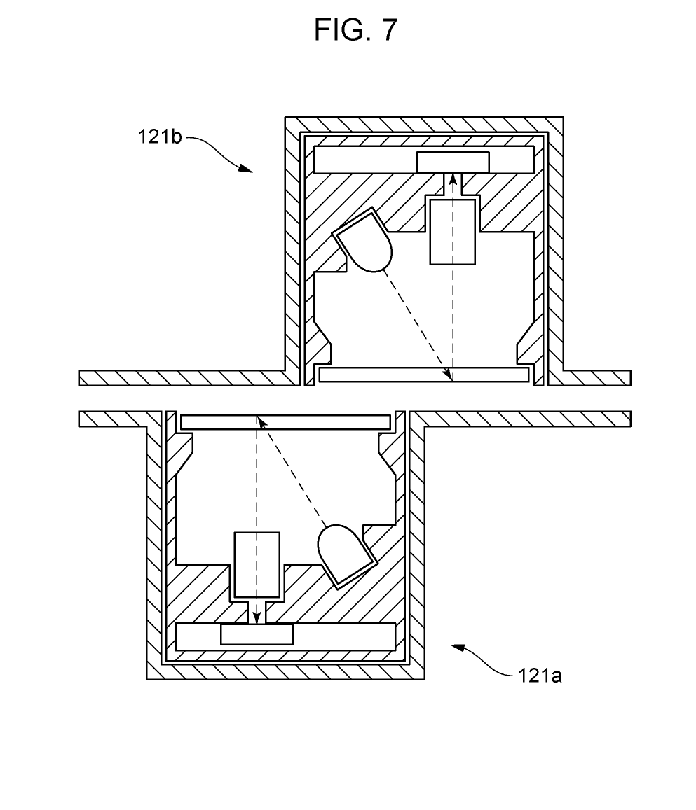

A third embodiment will now be described using FIGS. 6 and 7. The description of the same components as those of the first and second embodiments will be omitted. FIG. 6 is an enlarged view of an image reading unit 120 according to the present embodiment. FIG. 7 is an enlarged view of sensor units 121a and 121b.

A document fed from a document feeding portion 122 to document registration rollers 123 is conveyed between the sensor units 121a and 121b disposed to face the respective surfaces of the document, and images on both surfaces of the document are read. Although the image reading unit 120 of the present embodiment includes the two sensor units 121a and 121b for reading images on both surfaces of a document, a compact apparatus size can be achieved as long as at least one of the two sensor units 121a and 121b is at least partially disposed in the region specified in the first embodiment.

An image forming apparatus which offers high productivity in reading images on recording materials and documents will now be described.

### Fourth Embodiment

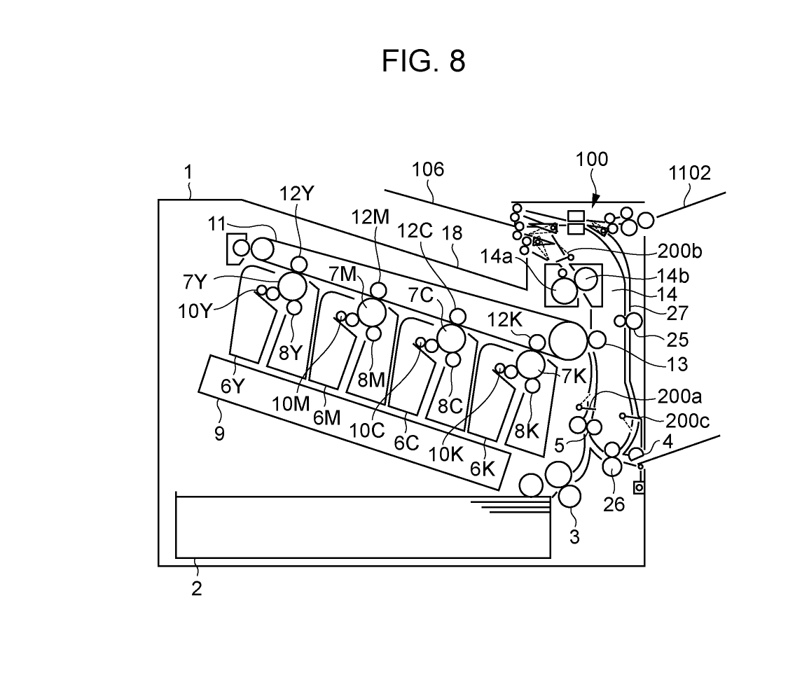

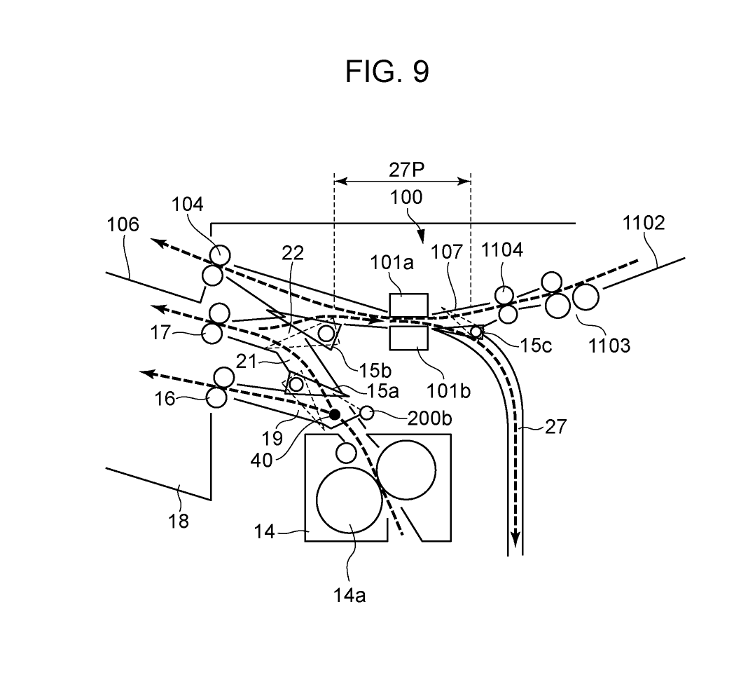

An image forming apparatus according to a fourth embodiment of the present invention will now be described using FIGS. 8 and 9. FIG. 9 is a partial enlarged view of FIG. 8. Although the image forming apparatus according to the fourth or any subsequent embodiment is a full-color laser beam printer including a plurality of photosensitive drums, it may be a monochrome image forming apparatus including only one photosensitive drum.

(Feeding Unit)

FIG. 8 is a cross-sectional view of the image forming apparatus 1. The cassette 2 that holds recording materials therein is mounted at the bottom of the image forming apparatus 1 in such a manner that it can be pulled out. The cassette feeding portion 3 is disposed near an end portion of the cassette 2. The manual feeding portion 4 is disposed on the right-hand side of the image forming apparatus 1. The cassette feeding portion 3 and the manual feeding portion 4 are both configured to feed recording materials one by one to the registration rollers 5. The conveyance sensor 200a that detects passage of a recording material is disposed downstream of the registration rollers 5 in the recording-material conveying direction.

(Image Forming Unit and Fixing Unit)

The image forming apparatus 1 includes the image forming unit 6. The image forming unit 6 of the present embodiment includes the four image forming stations 6Y, 6M, 6C, and 6K of yellow, magenta, cyan, and black. The image forming unit 6 also includes the photosensitive members 7Y, 7M, 7C, and 7K each serving as an image bearing member, and the chargers 8Y, 8M, 8C, and 8K each configured to uniformly charge the surface of a corresponding one of the photosensitive members 7Y, 7M, 7C, and 7K. The image forming unit 6 further includes the scanner unit 9 that emits laser beams on the basis of image information to form electrostatic latent images on the photosensitive members 7Y, 7M, 7C, and 7K, and the developing units 10Y, 10M, 10C, and 10K that cause toners to adhere to the electrostatic latent images to develop the electrostatic latent images. The image forming unit 6 further includes the primary transfer portions 12Y, 12M, 12C, and 12K that transfer the toner images on the photosensitive members 7Y, 7M, 7C, and 7K to the electrostatic transfer belt 11. The toner images on the electrostatic transfer belt 11 are transferred onto a front surface (first surface) of a recording material at the secondary transfer portion 13. The resulting toner image on the recording material is fixed by the fixing unit 14. The fixing unit 14 includes the fixing roller (first rotary member) 14a that has an internal heat source therein, and the pressure roller (second rotary member) 14b that forms a fixing nip with the fixing roller 14a to convey the recording material therebetween. The recording material is heated at the fixing nip while being conveyed. An unfixed image on the recording material is thus fixed to the recording material. Of the fixing roller (first rotary member) 14a and the pressure roller (second rotary member) 14b, only the fixing roller (first rotary member) 14a comes into contact with the unfixed image.

(Discharge Portion and Reversing Portion)

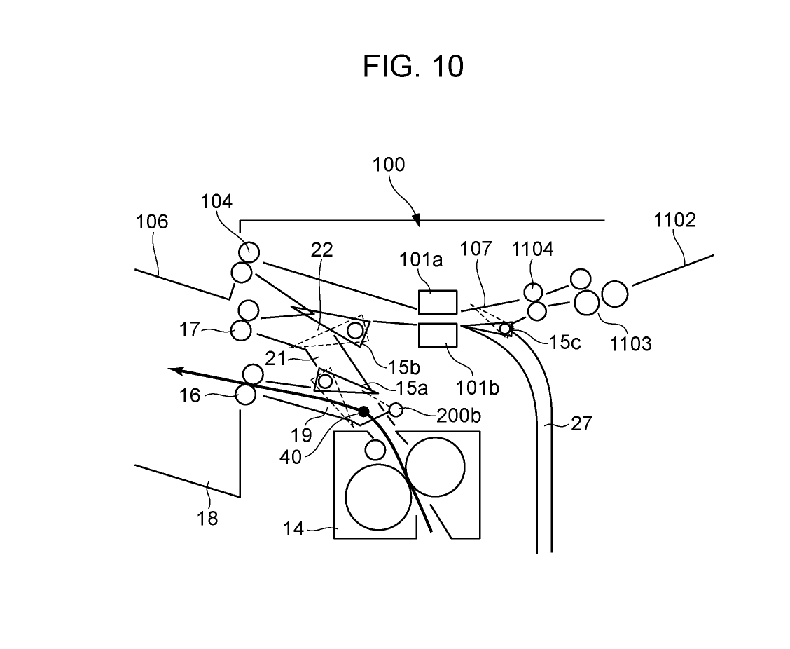

As illustrated in FIG. 9, the conveyance sensor 200b is disposed downstream of the fixing unit 14. When the conveyance sensor 200b is pushed up by the recording material to the position indicated by dotted line in the drawing, the conveyance sensor 200b determines that the recording material is being properly conveyed. Then, if a first flapper 15a is at the position indicated by solid line in the drawing, the recording material is guided to the discharge roller pair (discharge portion) 16 disposed to the upper left of the fixing unit 14 (see FIG. 10). If the first flapper 15a is at the position indicated by broken line in the drawing, the recording material is guided to the switchback roller pair (reversing portion) 17 disposed above the discharge roller pair 16. The switchback roller pair 17 is a roller pair that reverses the recording material in such a manner that instead of the leading edge, the trailing edge of the recording material that has passed through the fixing unit 14 is conveyed. The discharge roller pair 16 is a roller pair that discharges a recording material having a fixed image thereon to the outside of the apparatus. The recording material conveyed to the discharge roller pair 16 is discharged onto the recording-material supporting portion (recording-material discharge tray) 18. The discharge conveying path 19 guides the recording material from the fixing unit 14 to the discharge portion 16.

(Image Reading Unit)

The image reading unit 100 that reads an image on a document will now be described. The image reading unit 100 is disposed inside the image forming apparatus 1 and located above the fixing unit 14. The image reading unit 100 includes sensor units (image sensors) 101a and 101b that read an image on a document, a document feeding tray 1102 that holds documents thereon, and a document feeding portion 1103 that feeds and conveys documents. The image reading unit 100 further includes document registration rollers 1104 that convey the document toward the sensor units 101a and 101b, the document discharge roller pair (document discharge portion) 104 that discharges the document after image reading, and a document discharge tray 106 that holds documents after image reading. The configuration of the sensor units 101a and 101b is not described, as it is the same as that illustrated in FIG. 3.

(Document Feeding and Discharge Operation, Document Reading Operation)

A document feeding and discharge operation, and an operation of reading an image on a document, will now be described. A second flapper 15b, a third flapper 15c, and the image reading unit 100 are disposed in the upper right part of the image forming apparatus 1.

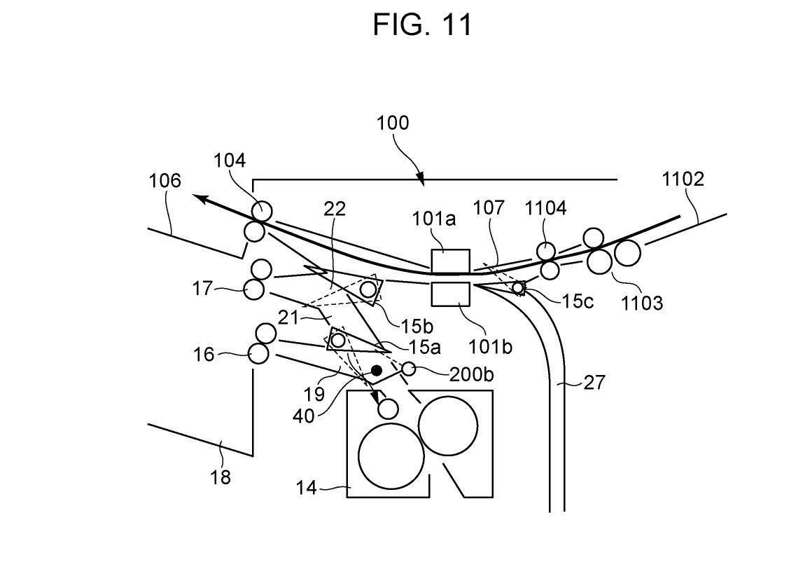

For reading an image on a document, the second flapper 15b and the third flapper 15c are each moved to the position indicated by solid line in the drawing to form a document conveying path 107 which conveys the document from the document registration rollers 1104 to the document discharge roller pair 104 (see FIG. 11). Then, the document feeding portion 1103 conveys documents one by one from the document feeding tray 1102 to the document registration rollers 1104. The document is further conveyed by the document registration rollers 1104 to the sensor unit 101a, which reads an image on the document.

The sensor units 101a and 101b are disposed inside the image forming apparatus 1 in such a manner that their surfaces where image reading takes place (see the reading surface 201 in FIG. 3) face each other, with the document conveying path 107 interposed therebetween. The sensor units 101a and 101b may each be a contact image sensor (CIS), such as that illustrated in FIG. 3. With the two sensor units 101a and 101b disposed to face each other, images on both surfaces of the document, or images printed on both surfaces of a recording material (described below), conveyed between the sensor units 101a and 101b can be read in a single pass. When there is no need to read images on both surfaces of the document or recording material at the same time, only one of the sensor units 101a and 101b may be provided. In this case, the sensor unit 101a is removed, with the sensor unit 101b left in place.

After image reading, the document is conveyed by the document discharge roller pair 104 and discharged onto the document discharge tray 106. Image data read by the sensor unit 101a is either stored as electronic data in a computer on a network, or converted to print data by the control unit (not shown) and printed on a recording material.

The document feeding tray 1102 is disposed above the manual feeding portion 4 (see FIG. 8), and the document discharge tray 106 is disposed above the recording-material supporting portion 18. The direction in which the user accesses the apparatus to load (or place) documents or recording materials is the same as the direction in which the user accesses the apparatus to collect discharged documents or recording materials. This makes it easier for the user to use the apparatus.

(Printing on Back Surface of Recording Material)

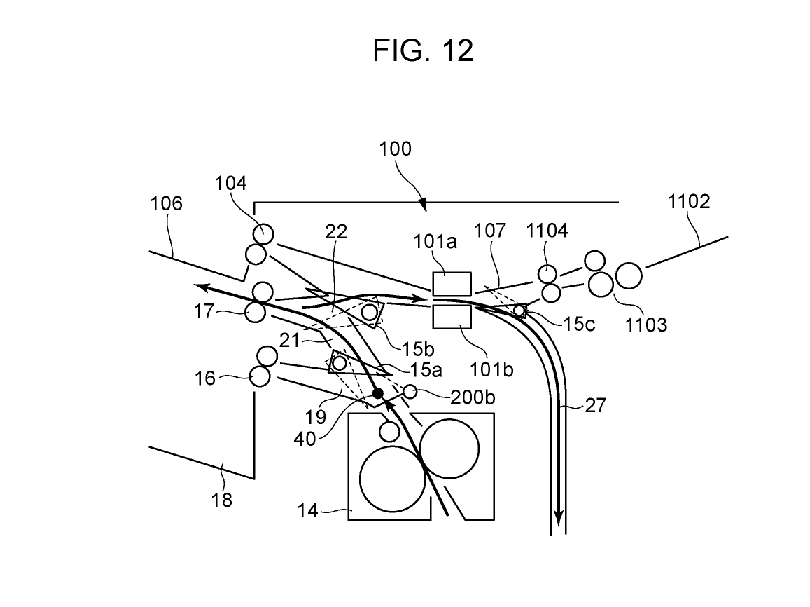

For printing on the back surface (second surface) of the recording material, the first flapper 15a is moved to the position indicated by broken line, and the second flapper 15b is moved to the position indicated by solid line. This forms a first conveying path 21 that conveys (guides) the recording material from a first branch point 40 in the discharge conveying path 19 to the switchback roller pair 17. The recording material is thus conveyed from the fixing unit 14 to the switchback roller pair 17. Then, by rotating the switchback roller pair 17 in such a manner that the the recording material is conveyed leftward in FIG. 9, the recording material is conveyed until the trailing edge of the recording material passes through the tip of the second flapper 15b. By then moving the second flapper 15b to the position indicated by broken line, a second conveying path 22 is formed, which conveys (guides) the recording material from the switchback roller pair 17 to the sensor units 101a and 101b. The third flapper 15c is then moved to the position indicated by broken line. The switchback roller pair 17 is stopped and rotated in such a manner that the recording material is conveyed rightward in FIG. 9. The recording material is thus conveyed through the second conveying path 22 and the sensor units 101a and 101b toward a duplex conveying path 27. The second flapper 15b and the third flapper 15c are moved when a predetermined time period elapses after the trailing edge of the recording material passes through the conveyance sensor 200b. The conveyance sensor 200c is disposed in the duplex conveying path 27 (see FIG. 8). With the same mechanism as the conveyance sensor 200a, the conveyance sensor 200c determines whether the recording material is being properly conveyed. FIG. 12 illustrates how a recording material flows during printing on the back surface.

(Refeeding)

The recording material conveyed to the duplex conveying path 27 passes through a duplex conveying roller pair 25 and a roller pair 26 (see FIG. 8) and is conveyed to the registration rollers 5 again. The recording material is then further conveyed through the secondary transfer portion 13, the fixing unit 14, and the discharge conveying path 19 (see FIG. 12) to the discharge roller pair 16 and discharged onto the recording-material supporting portion 18.

(Reading of Image (Printed Image) on Recording Material)

For reading a toner image fixed on a recording material by the fixing unit 14, the recording material is conveyed exactly in the same process as in the case of printing on the back surface of the recording material (see FIG. 12). The image on the recording material is read by the sensor unit 101b as the recording material passes through the sensor unit 101b. The read image information is subjected to processing, such as recording or feature extraction, by an image information processing unit (not shown). By using information obtained by such processing, evaluation of a printed image or adjustment of image forming conditions can be made. The read image information may be stored in an electronic recording unit, such as an internal memory (not shown) of the apparatus or a computer (not shown) on a network.

In the image forming apparatus 1 of the present embodiment, the duplex conveying path 27 is partially a common conveying path 27P (see FIG. 9) shared with the document conveying path 107. The sensor unit (reading unit) 101b is disposed on a side of the common conveying path 27P facing one of two surfaces of the recording material reversed by the reversing portion 17, the one being a surface that has more recently come into contact with the first rotary member 14a. The sensor unit 101b has the capability of reading a fixed image on the recording material and reading an image on a document. An image forming apparatus can thus be provided, which offers high productivity in reading images on recording materials and documents.

In the image forming apparatus 1 of the present embodiment, the document conveying direction (leftward in FIG. 9) in which a document fed from the document feeding portion 1103 is conveyed for reading an image on the document, is opposite the recording-material conveying direction (rightward in FIG. 9) in which a recording material is conveyed for reading a fixed image on the recording material. Images on the document and the recording material conveyed in the opposite directions are read by the sensor units 101a and 101b. Thus, the feeding areas for feeding the recording material and the document are both on the right-hand side in FIG. 8, and the discharge areas for discharging the recording material and the document are both on the left-hand side in FIG. 8. With this configuration, it is possible to achieve both good user accessibility and high productivity in reading images on recording materials and the documents.

### Fifth Embodiment

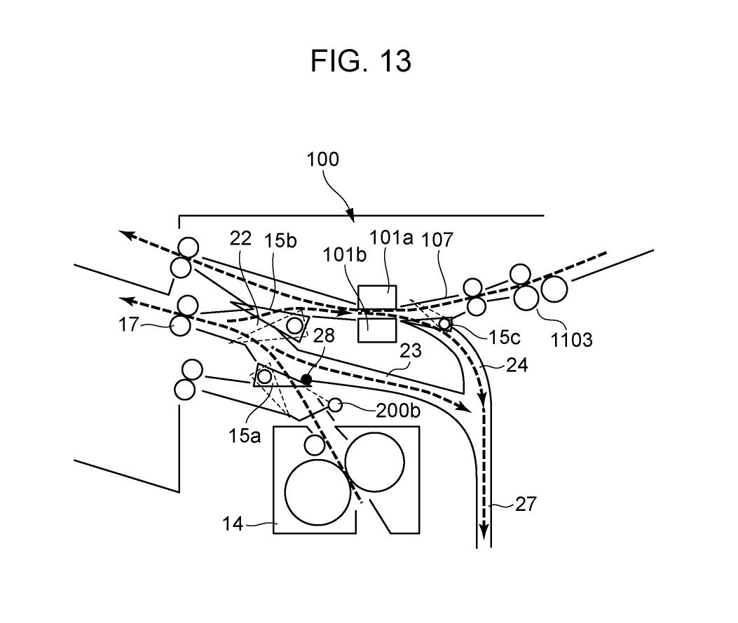

A printer of a fifth embodiment is the same as that of the fourth embodiment, except the process of printing on the back surface of the recording material and the process of reading a printed image on the recording material. The description of the same components as those of the fourth embodiment will be omitted. On the basis of FIG. 13, characteristic differences between the fourth and fifth embodiments will be described in terms of the process of printing on the back surface of the recording material and the process of reading a printed image on the recording material. The same components as those of the fourth embodiment are denoted by the same reference numerals.

(Printing on Back Surface of Recording Material)

For printing on the back surface of the recording material, the first flapper 15a is moved to the position indicated by broken line in the drawing, and the second flapper 15b is moved to the position indicated by solid line in the drawing, so that the recording material is conveyed from the fixing unit 14 to the switchback roller pair 17. Then, by rotating the switchback roller pair 17 in such a manner that the recording material is conveyed leftward in FIG. 13, the recording material is conveyed until the trailing edge of the recording material passes through a conveying guide end 28. By then moving the first flapper 15a to the position indicated by solid line, with the second flapper 15b kept at the position indicated by solid line, a conveying path (duplex conveying path) 23 is formed, which conveys the recording material from the switchback roller pair 17 to the duplex conveying path 27. The conveying path 23 is disposed inside the image forming apparatus 1 in such a manner that it is located between the fixing unit 14 and the sensor units 101a and 101b and joins the duplex conveying path 27. Then, by stopping the switchback roller pair 17 and rotating it to convey the recording material rightward in FIG. 13, the recording material is conveyed through the conveying path 23 toward the duplex conveying path 27.

(Reading of Image (Printed Image) on Recording Material)

For reading a toner image fixed on a recording material by the fixing unit 14, the first flapper 15a is moved to the position indicated by broken line and the second flapper 15b is moved to the position indicated by solid line, so that the recording material is conveyed from the fixing unit 14 to the switchback roller pair 17. Then, by rotating the switchback roller pair 17 to move the recording material leftward in FIG. 13, the recording material is conveyed until the trailing edge of the recording material passes through the tip of the second flapper 15b. The second flapper 15b and the third flapper 15c each are then further moved to the position indicated by broken line. This forms the conveying path 22 that conveys the recording material from the switchback roller pair 17 to the sensor units 101a and 101b, and a conveying path 24 that conveys the recording material from the sensor units 101a and 101b to the duplex conveying path 27. The second flapper 15b and the third flapper 15c are moved with the same timing as in the first embodiment. Then, by stopping the switchback roller pair 17 and rotating it to move the recording material rightward in FIG. 13, the recording material is conveyed through the conveying path 22, the sensor units 101a and 101b, and the conveying path 24 toward the duplex conveying path 27. The sensor unit 101b reads an image printed on the recording material during the conveyance. The operation that follows will not be described, as it is the same as that described in the first embodiment.

In the present embodiment, the sensor unit (reading unit) 101b is disposed in the document conveying path 107. The conveying path 22 that connects the switchback roller pair (reversing portion) 17 to the document conveying path 107 and the conveying path 24 that connects the document conveying path 107 to the duplex conveying path 27 are provided, and the sensor unit 101b has the capability of reading a fixed image on the recording material and an image on the document. An image forming apparatus can thus be provided, which offers high productivity in reading images on recording materials and documents. Since the document conveying path 107 and the duplex conveying path 23 are separate, reading of an image on the document and conveyance of the recording material along the duplex conveying path 23 for printing on the second surface of the recording material can be carried out at the same time.

### Sixth Embodiment

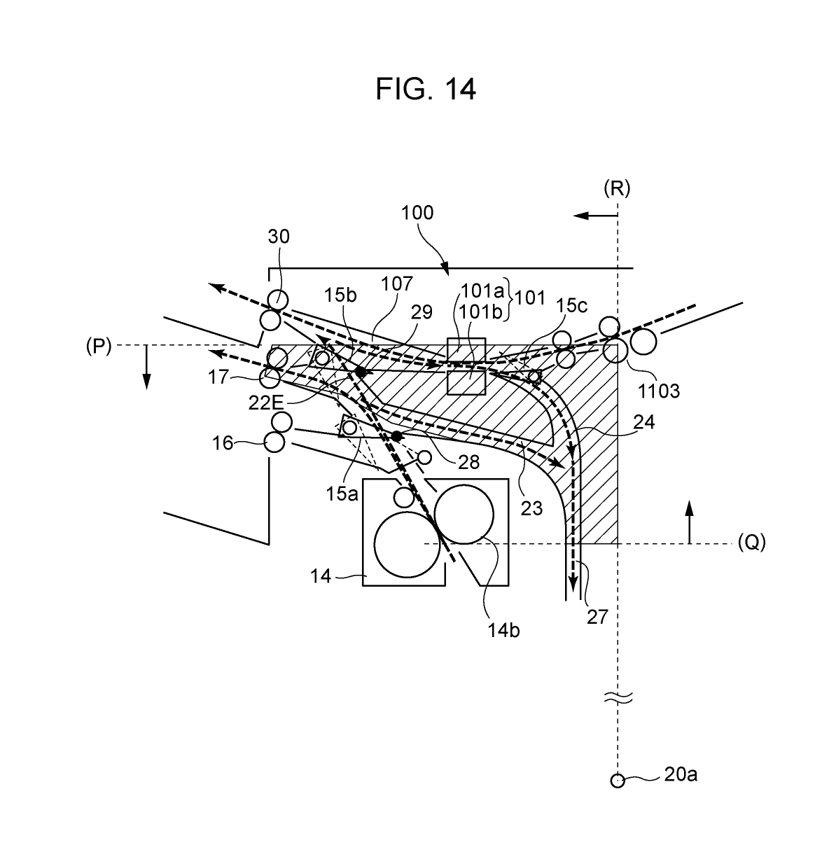

For reading an image on a recording material in a printer of a sixth embodiment illustrated in FIG. 14, a document discharge roller pair 30 serves as a reversing portion (i.e., switchback roller pair 17 in the fifth embodiment) that revers the recording material. For forming an image on the second surface of the recording material, the switchback roller pair 17 reverses the recording material. The recording material that has passed through the fixing unit 14 is guided through a conveying path 22E to the document conveying path 107 (or to the document discharge roller pair 30). The other operations are the same as those in the fifth embodiment and their description will be omitted. With this configuration, an image forming apparatus can be provided, which offers high productivity in reading images on recording materials and documents. Again, since the document conveying path 107 and the duplex conveying path 23 are separate, reading of an image on the document and conveyance of the recording material along the duplex conveying path 23 for printing on the second surface of the recording material can be carried out at the same time.

The duplex conveying path 23 is formed in such a manner as to avoid the fixing unit 14, particularly the pressure roller 14b. Therefore, an area which serves no function in an SFP is created in the region below the horizontal plane (P) defined by the upper end of the reversing rollers 17, above the horizontal plane (Q) defined by the lower end of the pressure roller 14b, and outside the duplex conveying path 23. Specifically, this is the region diagonally shaded in FIG. 14. This diagonally shaded region is also surrounded by the vertical plane (R) defined by the hinge 20a (about which the opening and closing member 20 pivots). In the image forming apparatus 1 of the present embodiment, as in the first to third embodiments, the image reading unit 100 is positioned in such a manner that the sensor unit 101 is at least partially disposed in this diagonally shaded region. This layout of the sensor unit 101 is adopted in other embodiments, as well as in the first to third embodiments and the sixth embodiment.

### Seventh Embodiment

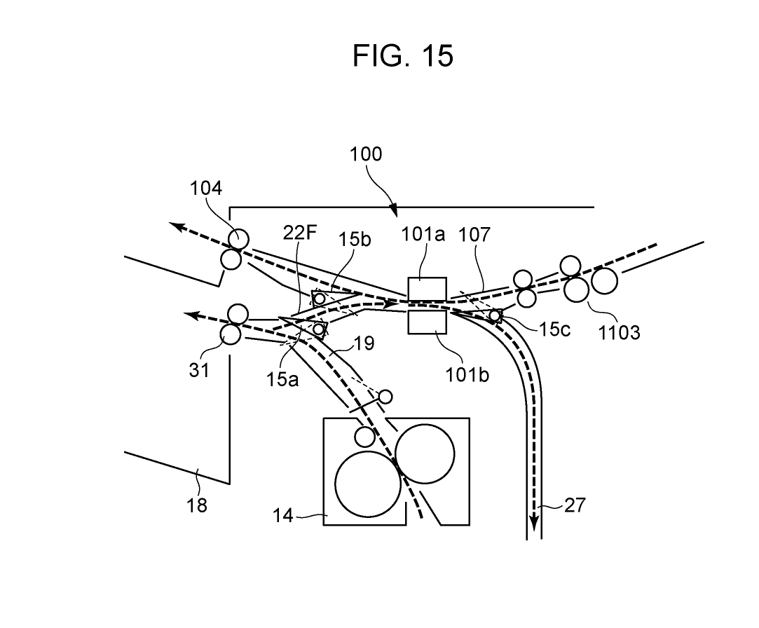

In a printer of a seventh embodiment illustrated in FIG. 15, a discharge roller pair (switchback roller pair, discharge reversing portion) 31 that discharges a recording material onto the recording-material discharge tray 18 serves as a switchback roller pair. For reading an image on the recording material, the discharge roller pair 31 serves as a reversing portion (i.e., switchback roller pair 17 in the fourth embodiment) that reverses the recording material. For forming an image on the second surface of the recording material, the switchback roller pair 31 also reverses the recording material. A conveying path 22F conveys the recording material from the discharge roller pair (switchback roller pair) 31 to the sensor units 101a and 101b (or to the document conveying path 107). The other operations are the same as those in the fourth embodiment and their description will be omitted. With this configuration, an image forming apparatus can be provided, which offers high productivity in reading images on recording materials and documents. The present embodiment requires a smaller number of conveying roller pairs and thus can simplify the configuration of conveying paths.

### Eighth Embodiment

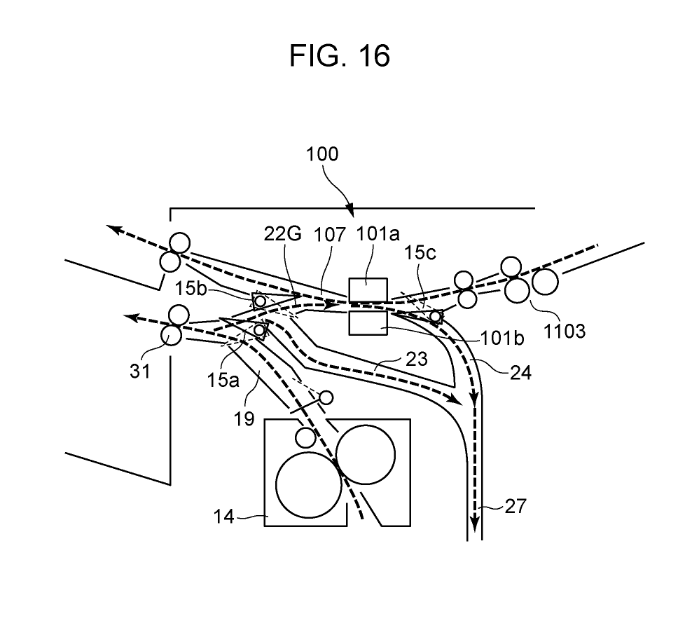

In a printer of an eighth embodiment illustrated in FIG. 16, the discharge roller pair 31 that discharges a recording material onto the recording-material discharge tray 18 also serves as a switchback roller pair. For reading an image on the recording material, the discharge roller pair 31 serves as a reversing portion (i.e., switchback roller pair 17 in the fifth embodiment) that reverses the recording material. For forming an image on the second surface of the recording material, the switchback roller pair 31 also reverses the recording material. A conveying path 22G conveys the recording material from the discharge roller pair (switchback roller pair) 31 to the sensor units 101a and 101b (or to the document conveying path 107). The other operations are the same as those in the fifth embodiment and their description will be omitted. With this configuration, an image forming apparatus can be provided, which offers high productivity in reading images on recording materials and documents. The present embodiment requires a smaller number of conveying roller pairs and thus can simplify the configuration of conveying paths. Also, since the document conveying path 107 and the duplex conveying path 23 are separate, reading of an image on the document and conveyance of the recording material along the duplex conveying path 23 for printing on the second surface of the recording material can be carried out at the same time.

### Ninth Embodiment

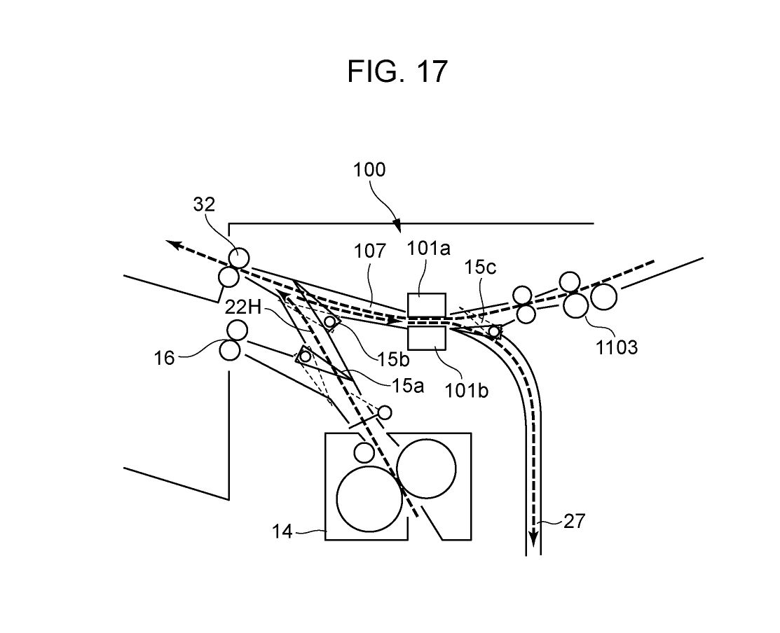

For reading an image on a recording material in a printer of a ninth embodiment illustrated in FIG. 17, a document discharge roller pair 32 serves as a reversing portion (i.e., switchback roller pair 17 in the sixth embodiment) that revers the recording material. For forming an image on the second surface of the recording material, the document discharge roller pair 32 also reverses the recording material. The recording material that has passed through the fixing unit 14 is guided through a conveying path 22H to the document conveying path 107 (or to the document discharge roller pair 32). The other operations are the same as those in the sixth embodiment and their description will be omitted. With this configuration, an image forming apparatus can be provided, which offers high productivity in reading images on recording materials and documents. The present embodiment requires a smaller number of conveying roller pairs and thus can simplify the configuration of conveying paths.

### Tenth Embodiment

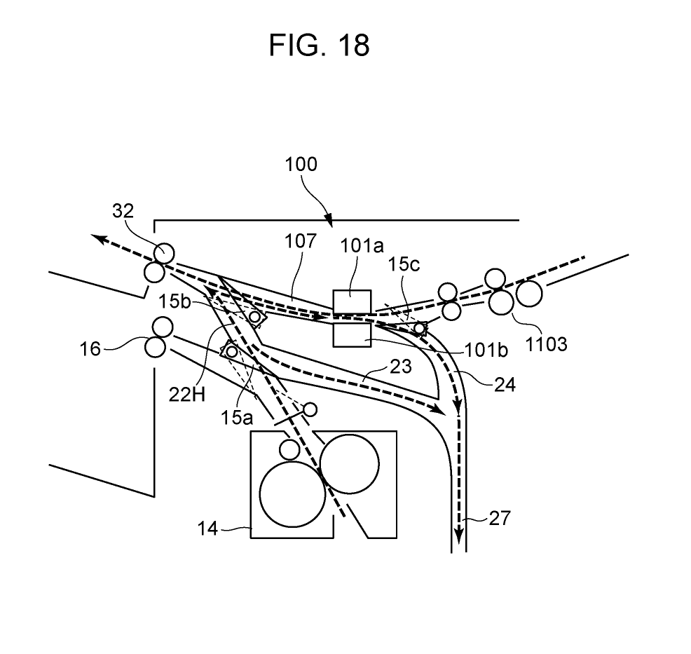

A printer of a tenth embodiment illustrated in FIG. 18 differs from the printer of the ninth embodiment in that it includes the duplex conveying path 23. For forming an image on the second surface of the recording material, the document discharge roller pair 32 reverses the recording material and guides it to the duplex conveying path 23. The recording material that has passed through the fixing unit 14 is guided through the conveying path 22H to the document conveying path 107 (or to the document discharge roller pair 32). The other operations are the same as those in the ninth embodiment and their description will be omitted. With this configuration, an image forming apparatus can be provided, which offers high productivity in reading images on recording materials and documents. The present embodiment requires a smaller number of conveying roller pairs and thus can simplify the configuration of conveying paths. Also, since the document conveying path 107 and the duplex conveying path 23 are separate, reading of an image on the document and conveyance of the recording material along the duplex conveying path 23 for printing on the second surface of the recording material can be carried out at the same time.

Other exemplary image forming apparatuses will now be described, which can reduce transfer of heat from the fixing unit 14 to the image reading unit 100 and requires less time for image reading.

### Eleventh Embodiment

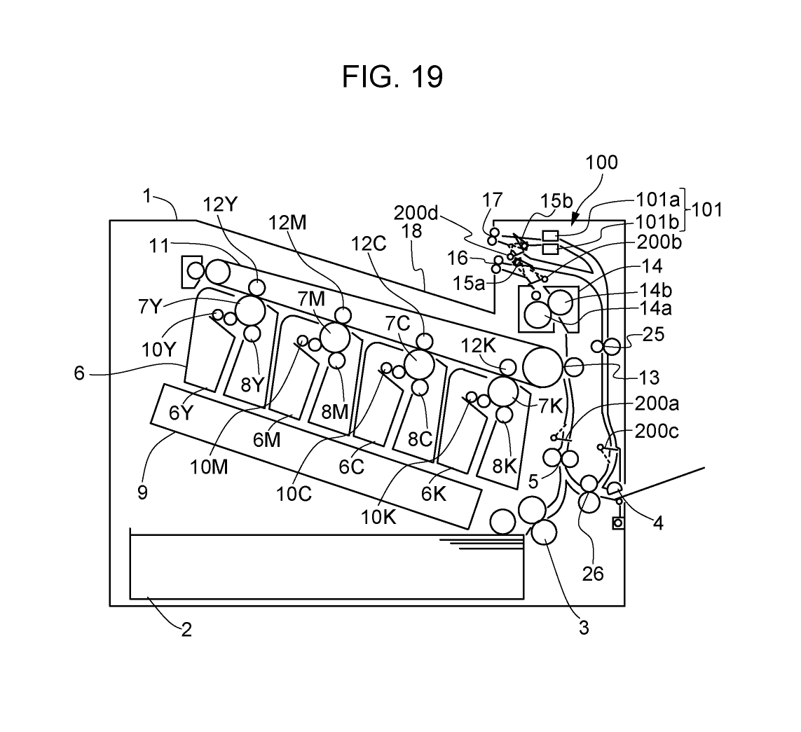

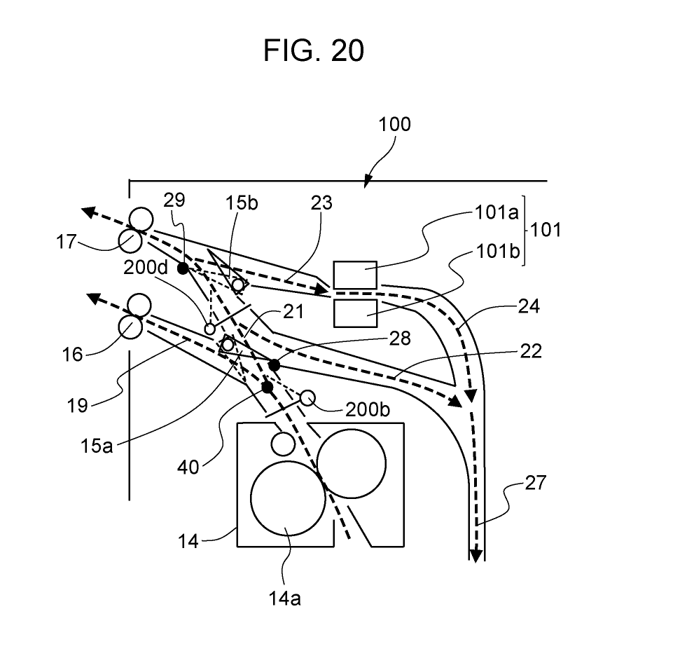

An image forming apparatus according to an eleventh embodiment of the present invention will be described using FIGS. 19 and 20. FIG. 20 is a partial enlarged view of FIG. 19. Although the image forming apparatus according to the eleventh or any subsequent embodiment is a full-color laser beam printer including a plurality of photosensitive drums, it may be a monochrome image forming apparatus including only one photosensitive drum.

(Feeding Unit)

FIG. 19 is a cross-sectional view of the image forming apparatus 1. The cassette 2 that holds recording materials therein is mounted at the bottom of the image forming apparatus 1 in such a manner that it can be pulled out. The cassette feeding portion 3 is disposed near an end portion of the cassette 2. The manual feeding portion 4 is disposed on the right-hand side of the image forming apparatus 1. The cassette feeding portion 3 and the manual feeding portion 4 are both configured to feed recording materials one by one to the registration rollers 5. The conveyance sensor 200a that detects passage of a recording material is disposed downstream of the registration rollers 5 in the recording-material conveying direction.

(Conveyance Sensor)

The conveyance sensor 200a will now be described using FIG. 25. The conveyance sensor 200a includes a sensor arm 221 and a detecting portion 224. The sensor arm 221 is disposed to protrude across a conveying path 223 and pivotally supported about a shaft 222. The detecting portion 224 is configured to detect the motion of the sensor arm 221. The sensor arm 221 is retained by a biasing means (not shown), such as a spring, at the position indicated by solid line. When a recording material 225 moves in the direction of solid arrow in FIG. 25 and reaches the conveyance sensor 200a, the sensor arm 221 is pushed upward by the recording material 225 to the position indicated by broken line in FIG. 25. The detecting portion 224 detects the motion of the sensor arm 221 and transmits, to a control means (not shown), a signal indicating that the recording material 225 has reached the conveyance sensor 200a. When the recording material 225 further moves and an edge 226 of the recording material 225 on the downstream side in the conveying direction leaves the sensor arm 221, then the sensor arm 221 moves to the position indicated by solid line in FIG. 25. An edge of the recording material 225 facing the downstream side in the conveying direction is defined as a leading edge, and the other edge of the recording material 225 facing the upstream side in the conveying direction is defined as a trailing edge. The detecting portion 224 detects the motion of the sensor arm 221 and transmits, to the control means (not shown), a signal indicating that the recording material 225 has passed through the conveyance sensor 200a. The conveyance sensors 200b and 200c (described below) have the same structure as the conveyance sensor 200a.

(Image Forming Unit and Fixing Unit)

The image forming apparatus 1 includes the image forming unit 6. The image forming unit 6 of the present embodiment includes the four image forming stations 6Y, 6M, 6C, and 6K of yellow, magenta, cyan, and black. The image forming unit 6 also includes the photosensitive members 7Y, 7M, 7C, and 7K each serving as an image bearing member, and the chargers 8Y, 8M, 8C, and 8K each configured to uniformly charge the surface of a corresponding one of the photosensitive members 7Y, 7M, 7C, and 7K. The image forming unit 6 further includes the scanner unit 9 that emits laser beams on the basis of image information to form electrostatic latent images on the photosensitive members 7Y, 7M, 7C, and 7K, and the developing units 10Y, 10M, 10C, and 10K that cause toners to adhere to the electrostatic latent images to develop the electrostatic latent images. The image forming unit 6 further includes the primary transfer portions 12Y, 12M, 12C, and 12K that transfer the toner images on the photosensitive members 7Y, 7M, 7C, and 7K to the electrostatic transfer belt 11. The toner images on the electrostatic transfer belt 11 are transferred onto a front surface (first surface) of a recording material at the secondary transfer portion 13. The resulting toner image on the recording material is fixed by the fixing unit 14. The fixing unit 14 includes the fixing roller (first rotary member) 14a that has an internal heat source therein, and the pressure roller (second rotary member) 14b that forms a fixing nip with the fixing roller 14a to convey the recording material therebetween. The recording material is heated at the fixing nip while being conveyed. An unfixed image on the recording material is thus fixed to the recording material. Of the fixing roller (first rotary member) 14a and the pressure roller (second rotary member) 14b, only the fixing roller (first rotary member) 14a comes into contact with the unfixed image.

(Discharge Portion and Reversing Portion)

The conveyance sensor 200b is disposed downstream of the fixing unit 14. When the conveyance sensor 200b is pushed up by the recording material to the position indicated by dotted line in the drawing, the conveyance sensor 200b determines that the recording material is being properly conveyed. Then, if the first flapper 15a is at the position indicated by solid line in the drawing, the recording material is guided to the discharge roller pair (discharge portion) 16 disposed to the upper left of the fixing unit 14. If the first flapper 15a is at the position indicated by broken line in the drawing, the recording material is guided to the switchback roller pair (reversing portion) 17 disposed above the discharge roller pair 16. The switchback roller pair 17 is a roller pair that reverses the recording material in such a manner that instead of the leading edge, the trailing edge of the recording material that has passed through the fixing unit 14 is conveyed. The discharge roller pair 16 is a roller pair that discharges a recording material having a fixed image thereon to the outside of the apparatus. The recording material conveyed to the discharge roller pair 16 is discharged onto the recording-material supporting portion (recording-material discharge tray) 18. The discharge conveying path 19 guides the recording material from the fixing unit 14 to the discharge portion 16.

(Image Reading Unit)

The image reading unit 100 that reads an image on a recording material will now be described. The image reading unit 100 is disposed inside the image forming apparatus 1 and located above the fixing unit 14. The image reading unit 100 includes the sensor units (image sensors) 101a and 101b that read an image on a recording material. The configuration of the sensor units 101a and 101b is the same as that illustrated in FIG. 3 and its description will be omitted.

(Printing on Back Surface of Recording Material)

For printing on the back surface (second surface) of the recording material, the first flapper 15a is moved to the position indicated by broken line, and the second flapper 15b is moved to the position indicated by solid line. This forms the first conveying path 21 that guides the recording material from the first branch point 40 in the discharge conveying path 19 to the switchback roller pair 17. The recording material is thus conveyed from the fixing unit 14 to the switchback roller pair 17. Then, by rotating the switchback roller pair 17 in such a manner that the recording material is conveyed leftward in FIG. 20, the recording material is conveyed until the trailing edge of the recording material passes through the conveying guide end 28 illustrated in FIG. 20. By then moving the first flapper 15a to the position indicated by solid line, the second conveying path 22 is formed, which guides the recording material from the switchback roller pair 17 to the duplex conveying path 27. The second conveying path 22 is a conveying path that guides the recording material reversed by the switchback roller pair 17 to the duplex conveying path 27. The first flapper 15a and the second flapper 15b are moved when a predetermined time period elapses after the trailing edge of the recording material passes through the conveyance sensor 200b. By then stopping the switchback roller pair 17 and rotating it to convey the recording material rightward in FIG. 20, the recording material is conveyed through the second conveying path 22 toward the duplex conveying path 27. The second conveying path 22 is formed to pass above the fixing unit 14. The conveyance sensor 200c (see FIG. 19) is disposed in the duplex conveying path 27. With the same mechanism as the conveyance sensor 200a, the conveyance sensor 200c determines whether the recording material is being properly conveyed. The recording material conveyed to the duplex conveying path 27 passes through the duplex conveying roller pair 25 and the roller pair 26 (see FIG. 19) and is conveyed to the registration rollers 5 again. The recording material is then further conveyed through the secondary transfer portion 13, the fixing unit 14, and the discharge conveying path 19 to the discharge roller pair 16 and discharged onto the recording-material supporting portion 18.

(Reading of Image (Printed Image) on Recording Material)

When the image reading unit 100 reads a toner image fixed on the recording material by the fixing unit 14, the recording material is conveyed through the first conveying path 21 to the switchback roller pair 17. Then, by rotating the switchback roller pair 17 in such a manner that the recording material is conveyed leftward in FIG. 20, the recording material is conveyed until the trailing edge of the recording material passes through a point 29 (see FIG. 20) on the conveying guide. By then moving the first flapper 15a to the position indicated by solid line and moving the second flapper 15b to the position indicated by broken line, the third conveying path 23 is formed, which conveys the recording material from the switchback roller pair 17 to the image reading unit 100.

The sensor units 101a and 101b of the image reading unit 100 are disposed inside the image forming apparatus 1 and above the second conveying path 22, with their surfaces where image reading takes place (see the reading surface 201 in FIG. 3) facing each other. The sensor units 101a and 101b may each be a contact image sensor (CIS). With the two sensor units 101a and 101b disposed to face each other, images printed on both surfaces of the recording material conveyed between the sensor units 101a and 101b can be read at the same time. When there is no need to read images on both surfaces of the recording material at the same time, only one of the sensor units 101a and 101b may be provided. In this case, the sensor unit 101a is removed, with the sensor unit 101b left in place. The sensor unit 101b is disposed to face one of two surfaces of the recording material reversed by the reversing portion 17, the one being a surface that has more recently come into contact with the first rotary member 14a. With at least the sensor unit 101b of the two sensor units 101a and 101b, it is possible to reduce the time between when the recording material passes through the fixing unit 14 and when the sensor unit 101b reads an image. The time required for image reading can thus be reduced.

The first flapper 15a and the second flapper 15b are moved when a predetermined time period elapses after the trailing edge of the recording material passes through a conveyance sensor 200d disposed between the second flapper 15b and the switchback roller pair 17. The conveyance sensor 200d has the same mechanism as the conveyance sensor 200a described above. Then, by stopping the switchback roller pair 17 and rotating it to move the recording material rightward in FIG. 20, the recording material is conveyed through the third conveying path 23, the image reading unit 100, and the fourth conveying path 24 to the duplex conveying path 27. The fourth conveying path 24 extends above the second conveying path 22. The image reading unit 100 reads an image on the recording material being conveyed. The read image information is subjected to processing, such as recording or feature extraction, by an image information processing unit (not shown). By using information obtained by such processing, evaluation of a printed image or adjustment of image forming conditions can be made. The read image information may be stored in an electronic recording unit, such as an internal memory (not shown) of the apparatus or a computer (not shown) on a network.

In the image forming apparatus 1 of the present embodiment, the second conveying path 22 is disposed between the fixing unit 14 and the image reading unit 100. In other words, the second conveying path 22 is disposed between the fixing unit 14 and the third and fourth conveying paths 23 and 24. With this configuration, the transfer of heat generated in the fixing unit 14 is partially blocked by air in the second conveying path 22. This can reduce temperature rise in the image reading unit 100.

Of the two surfaces of the recording material, a surface on which an image is first formed in duplex printing is defined as a front surface and the other surface opposite the front surface is defined as a back surface. In the image forming apparatus 1 of the present embodiment, the front and back orientation of the recording material coming from the reversing portion 17 and passing through the third conveying path 23, the image reading unit 100, the fourth conveying path 24, and the duplex conveying path 27 is the same as the front and back orientation of the recording material coming from the reversing portion 17 and passing through the second conveying path 22 and the duplex conveying path 27. Specifically, of the two surfaces of the recording material passing through the second conveying path 22, a surface that has more recently come into contact with the first rotary member 14a is a surface facing downward in FIG. 20. Also, of the two surfaces of the recording material passing through the third and fourth conveying paths 23 and 24, a surface that has more recently come into contact with the first rotary member 14a is a surface facing downward in FIG. 20. That is, the recording material coming from the reversing portion 17 and passing through the third conveying path 23, the image reading unit 100, the fourth conveying path 24, and the duplex conveying path 27 does not need to be reversed before being conveyed to the image forming unit 6 (see FIG. 19) again. Therefore, as in the case of the recording material conveyed through the second conveying path 22, an image can be formed on the second surface promptly after image formation on the first surface and the time required for reading images on both surfaces can also be reduced.

As described above, the image forming apparatus 1 of the present embodiment can reduce transfer of heat from the fixing unit 14 to the image reading unit 100 and requires less time for image reading.

### Twelfth Embodiment

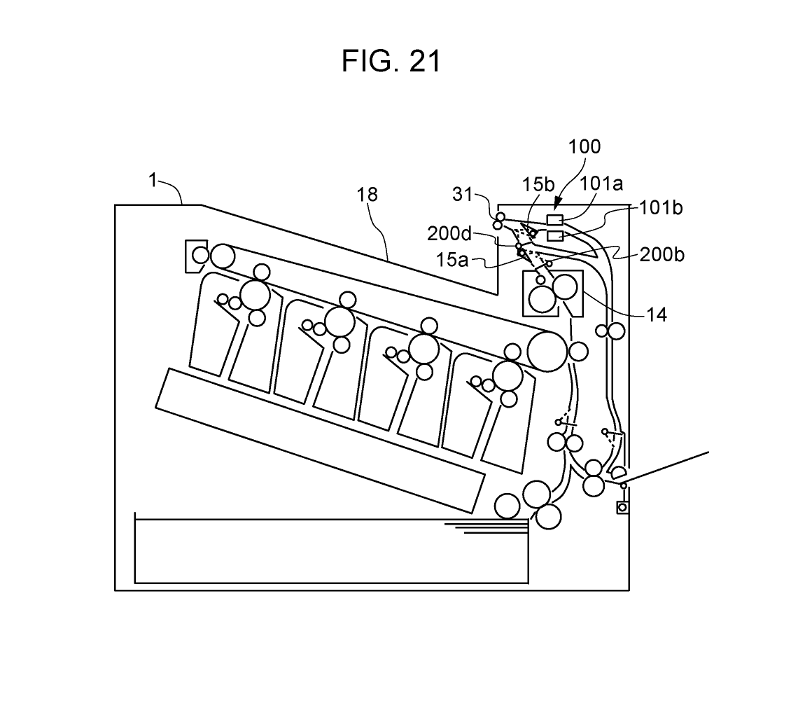

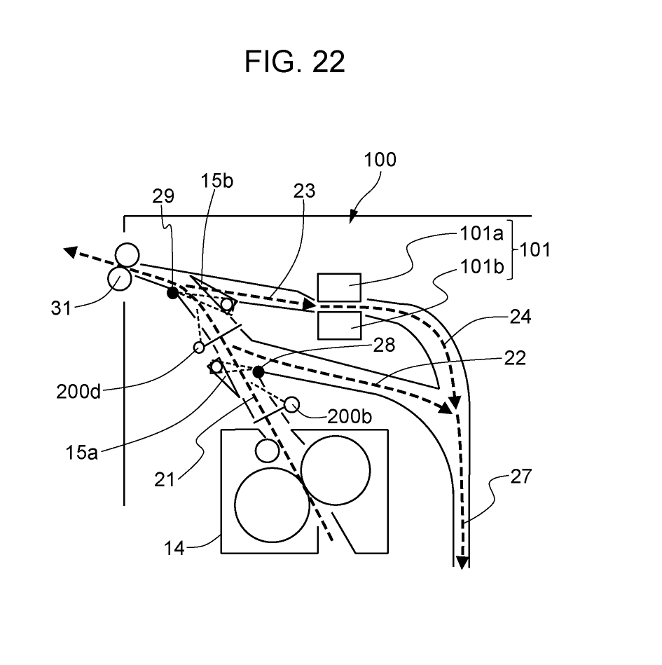

An image forming apparatus according to a twelfth embodiment will be described using FIGS. 21 and 22. The description of the same components as those of the eleventh embodiment will be omitted.

In the image forming apparatus 1 of the present embodiment, the discharge roller pair 16 and the switchback roller pair 17 described in the eleventh embodiment are replaced by the discharge roller pair (discharge reversing portion) 31.

When a recording material having a toner image fixed thereon by the fixing unit 14 is discharged out of the apparatus, the first flapper 15a and the second flapper 15b are each moved to the position indicated by solid line in the drawing. This forms the first conveying path 21 that conveys the recording material from the fixing unit 14 to the discharge roller pair 31. Then, by rotating the discharge roller pair 31 in such a manner that the recording material is conveyed leftward in FIG. 22, the recording material is discharged onto the recording-material supporting portion 18. An additional conveying path may be created, which conveys the recording material discharged from the discharge roller pair 31 to a post-processing device (not shown) disposed near the image forming apparatus 1, so that post-processing, such as separation, stapling, or sorting, can be performed on the recording material.

(Printing on Back Surface of Recording Material)

For printing on the back surface of the recording material, the recording material is conveyed from the fixing unit 14 through the first conveying path 21 to the discharge roller pair 31. Then, by rotating the discharge roller pair 31 in such a manner that the recording material is conveyed leftward in FIG. 22, the recording material is conveyed until the trailing edge of the recording material passes through the conveying guide end 28 illustrated in FIG. 22. By then moving the first flapper 15a to the position indicated by broken line and moving the second flapper 15b to the position indicated by solid line, the second conveying path 22 is formed, which guides the recording material from the discharge roller pair 31 to the duplex conveying path 27. The first flapper 15a and the second flapper 15b are moved with the same timing as in the eleventh embodiment. Then, by stopping the discharge roller pair 31 and rotating it to move the recording material rightward in FIG. 22, the recording material is conveyed through the second conveying path 22 to the duplex conveying path 27.

(Reading of Image (Printed Image) on Recording Material)

For reading a toner image fixed on the recording material by the fixing unit 14, the recording material is conveyed through the first conveying path 21 to the discharge roller pair 31. Then, by rotating the discharge roller pair 31 in such a manner that the recording material is conveyed leftward in FIG. 22, the recording material is conveyed until the trailing edge of the recording material passes through the point 29 (see FIG. 22) on the conveying guide. By then moving the first flapper 15a to the position indicated by solid line and moving the second flapper 15b to the position indicated by broken line, the third conveying path 23 is formed, which conveys the recording material from the discharge roller pair 31 to the image reading unit 100. The first flapper 15a and the second flapper 15b are moved with the same timing as in the eleventh embodiment. Then, by stopping the discharge roller pair 31 and rotating it to move the recording material rightward in FIG. 22, the recording material is conveyed through the third conveying path 23, the image reading unit 100, and the fourth conveying path 24 to the duplex conveying path 27. The image reading unit 100 reads an image on the recording material being conveyed.

In the image forming apparatus 1 of the present embodiment, as in the eleventh embodiment, the second conveying path 22 is disposed between the fixing unit 14 and the image reading unit 100. In other words, the second conveying path 22 is disposed between the fixing unit 14 and the third and fourth conveying paths 23 and 24. With this configuration, the transfer of heat generated in the fixing unit 14 is partially blocked by air in the second conveying path 22. This can reduce temperature rise in the image reading unit 100.

Of the two surfaces of the recording material, a surface on which an image is first formed in duplex printing is defined as a front surface and the other surface opposite the front surface is defined as a back surface. In the image forming apparatus 1 of the present embodiment, the front and back orientation of the recording material coming from the discharge reversing portion 31 and passing through the third conveying path 23, the image reading unit 100, the fourth conveying path 24, and the duplex conveying path 27 is the same as the front and back orientation of the recording material coming from the discharge reversing portion 31 and passing through the second conveying path 22 and the duplex conveying path 27. Therefore, as in the case of the recording material conveyed through the second conveying path 22, an image can be formed on the second surface promptly after image formation on the first surface and the time required for reading images on both surfaces can also be reduced.

As described above, the image forming apparatus 1 of the present embodiment can reduce transfer of heat from the fixing unit 14 to the image reading unit 100 and requires less time for image reading.

Again, with at least the sensor unit 101b of the two sensor units 101a and 101b, it is possible in the present embodiment to reduce the time between when the recording material passes through the fixing unit 14 and when the sensor unit 101b reads an image.

### Thirteenth Embodiment

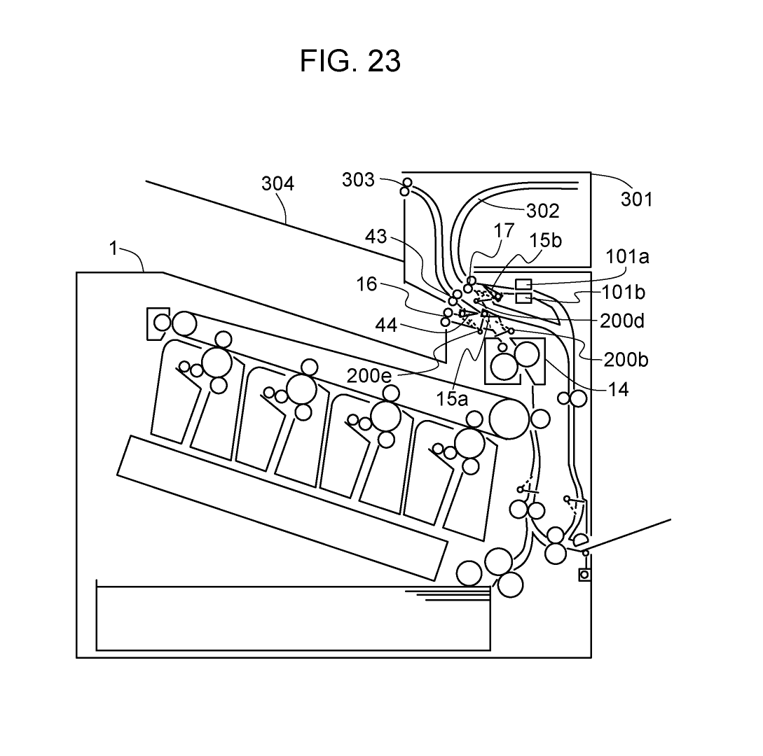

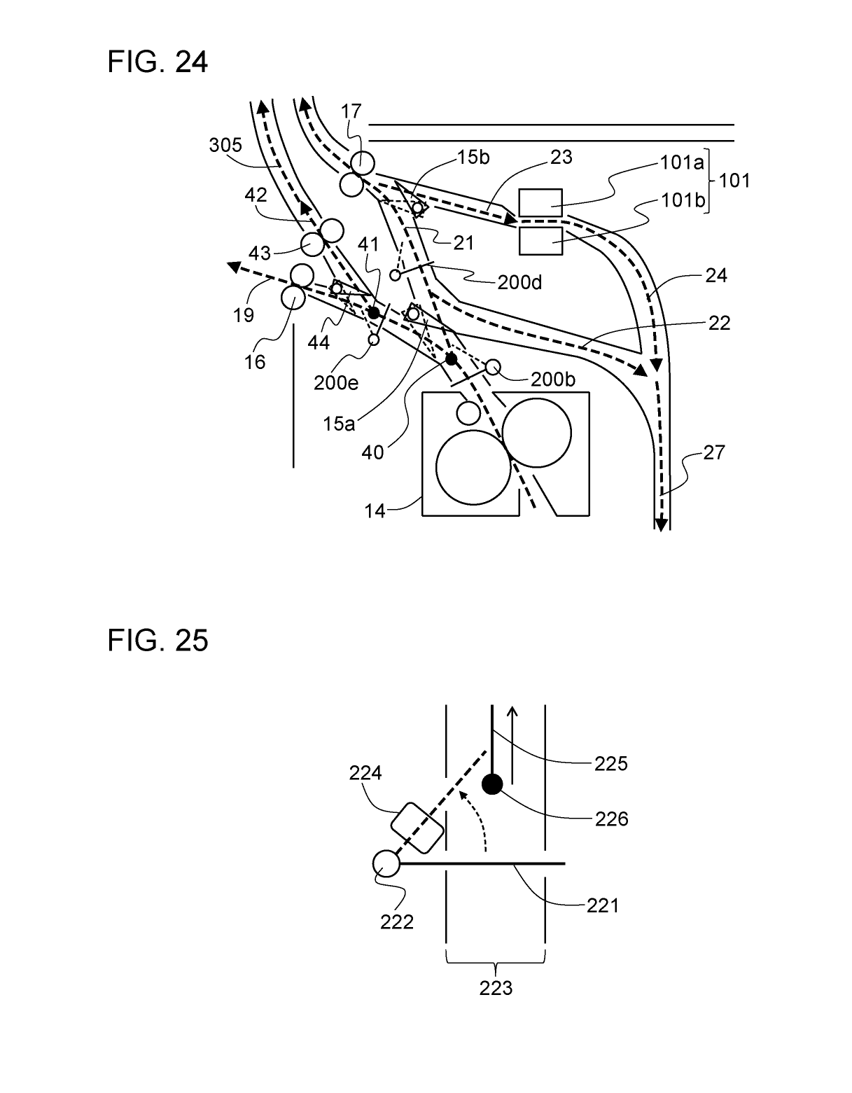

An image forming apparatus according to a thirteenth embodiment will be described using FIGS. 23 and 24. The description of the same components as those of the eleventh embodiment will be omitted.

The image forming apparatus 1 of the present embodiment is provided with a post-processing device 301 to the upper right thereof. The post-processing device 301 includes a recording-material retracting path 302, a post-processing discharge roller pair 303, and a post-processed recording-material supporting portion 304. The recording-material retracting path 302 is connected to the switchback roller pair 17 of the image forming apparatus 1 and configured to temporarily store the recording material partially discharged from the switchback roller pair 17. Although the post-processing device 301 of the present embodiment only has the capability of separating and discharging recording materials using the post-processed recording-material supporting portion 304, the post-processing device 301 may have the capability of stapling or sorting the recording materials.

When the recording material with a toner image fixed thereon by the fixing unit 14 is conveyed to the post-processing discharge roller pair 303, the first flapper 15a is moved to the position indicated by solid line in the drawing and a post-processing conveying flapper 44 is moved to the position indicated by broken line in the drawing. This forms a post-processing conveying path 42 (see FIG. 24) which conveys the recording material from a second branch point 41 between the first branch point 40 in the discharge conveying path 19 and the discharge roller pair 16 to a post-processing conveying roller pair 43. Then, the recording material is conveyed through a post-processing discharge conveying path 305 to the post-processing discharge roller pair 303 and discharged onto the post-processed recording-material supporting portion 304. A conveyance sensor 200e is disposed between the post-processing conveying flapper 44 and the first flapper 15a. With the same mechanism as the conveyance sensor 200a described in the eleventh embodiment, the conveyance sensor 200e determines whether the recording material is being properly conveyed. Although the post-processing conveying roller pair 43 is disposed inside the image forming apparatus 1 in the present embodiment, it may be disposed inside the post-processing device 301. For conveying the recording material to a post-processing device including a plurality of conveying paths other than the recording-material retracting path 302, there may be provided a plurality of post-processing conveying paths 42, post-processing conveying roller pairs 43, and post-processing conveying flappers 44.

The image forming apparatus 1 of the present embodiment includes conveying portions for conveying printed recording materials to the post-processing device 301 which performs post-processing, such as stapling or sorting. With this configuration, it is still possible to reduce transfer of heat from the fixing unit 14 to the image reading unit 100 and reduce time required for image reading.

The present invention can provide an image forming apparatus that is compact but includes, in a printer main body, a sensor unit capable of reading an image on a document.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image forming apparatus comprising:
an image forming unit configured to form an unfixed image on a recording material;
a fixing unit including a first rotary member configured to come into contact with the unfixed image on the recording material and a second rotary member configured to form a fixing nip with the first rotary member to convey the recording material therebetween, the fixing unit being configured to fix the unfixed image formed by the image forming unit onto the recording material;
a reversing roller configured to reverse the recording material in such a manner that instead of a leading edge, a trailing edge of the recording material that has passed through the fixing unit is conveyed;
a duplex conveying path configured to convey the reversed recording material to the image forming unit again;
a discharge portion configured to discharge the recording material out of the image forming apparatus; and
a sensor unit including a sensor that reads an image on a document,
wherein the sensor unit is at least partially disposed in a region below an upper end of the reversing roller, above a lower end of the second rotary member, and outside the duplex conveying path.

2. The image forming apparatus according to claim 1, further comprising:
a recording-material discharge tray onto which the recording material with the image formed thereon by the image forming unit is discharged; and
a document discharge tray onto which the document read by the sensor unit is discharged,
wherein the recording-material discharge tray and the document discharge tray are disposed at different positions in a horizontal direction.

3. The image forming apparatus according to claim 2, wherein a direction in which the recording material with the image formed by the image forming unit is discharged is opposite a direction in which the document is discharged.

4. The image forming apparatus according to claim 1,
wherein the image forming apparatus includes two sensor units configured to read images on both surfaces of the document; and
at least one of the two sensor units is at least partially disposed in the region below the upper end of the reversing roller, above the lower end of the second rotary member, and outside the duplex conveying path.

5. An image forming apparatus comprising:
an image forming unit configured to form an unfixed image on a recording material;
a fixing unit including a first rotary member configured to come into contact with the unfixed image on the recording material and a second rotary member configured to form a fixing nip with the first rotary member, the fixing unit being configured to fix the unfixed image on the recording material;
a reversing portion configured to reverse the recording material in such a manner that instead of a leading edge, a trailing edge of the recording material that has passed through the fixing unit is conveyed;
a duplex conveying path configured to convey the recording material reversed by the reversing portion to the image forming unit again;
a document feeding portion configured to feed a document;
a document discharge portion configured to discharge the document;
a document conveying path configured to connect the document feeding portion to the document discharge portion; and
a reading unit including a sensor that reads an image,
wherein the duplex conveying path is partially a common conveying path shared with the document conveying path;
the reading unit is disposed on a side of the common conveying path facing one of two surfaces of the recording material reversed by the reversing portion, the one being a surface that has more recently come into contact with the first rotary member; and
the reading unit has a capability of reading a fixed image on the recording material and an image on the document.

6. An image forming apparatus comprising:
an image forming unit configured to form an unfixed image on a recording material;
a fixing unit configured to fix the unfixed image on the recording material;
a reversing portion configured to reverse the recording material in such a manner that instead of a leading edge, a trailing edge of the recording material that has passed through the fixing unit is conveyed;
a duplex conveying path configured to convey the recording material reversed by the reversing portion to the image forming unit again;
a document feeding portion configured to feed a document;
a document discharge portion configured to discharge the document;
a document conveying path configured to connect the document feeding portion to the document discharge portion;
a reading unit disposed in the document conveying path and including a sensor that reads an image on the document; and
two conveying paths, one being configured to connect the reversing portion to the document conveying path and the other being configured to connect the document conveying path to the duplex conveying path,
wherein the reading unit has a capability of reading a fixed image on the recording material and an image on the document.

7. The image forming apparatus according to claim 6, further comprising:
a recording-material discharge tray; and
a discharge roller pair configured to discharge the recording material onto the recording-material discharge tray.

8. An image forming apparatus comprising:
an image forming unit configured to form an unfixed image on a recording material;
a fixing unit configured to fix the unfixed image on the recording material;
a reversing portion configured to reverse the recording material in such a manner that instead of a leading edge, a trailing edge of the recording material that has passed through the fixing unit is conveyed;
a duplex conveying path configured to convey the recording material reversed by the reversing portion to the image forming unit again;
a document feeding portion configured to feed a document;
a document discharge portion configured to discharge the document;
a document conveying path configured to connect the document feeding portion to the document discharge portion;
a reading unit disposed in the document conveying path and including a sensor that reads an image on the document; and
a conveying path configured to guide the recording material that has passed through the fixing unit to the document discharge portion,
wherein the reading unit has a capability of reading a fixed image on the recording material and an image on the document.

9. An image forming apparatus comprising:
an image forming unit configured to form an unfixed image on a recording material;
a fixing unit configured to fix the unfixed image on the recording material;
a discharge portion configured to discharge the recording material having the fixed image thereon out of the image forming apparatus;
a discharge conveying path configured to guide the recording material from the fixing unit to the discharge portion;
a reversing portion configured to reverse the recording material in such a manner that instead of a leading edge, a trailing edge of the recording material that has passed through the fixing unit is conveyed;
a duplex conveying path configured to guide the recording material reversed by the reversing portion to the image forming unit again;
a first conveying path configured to guide the recording material from a branch point in the discharge conveying path to the reversing portion;
a second conveying path configured to guide the recording material reversed by the reversing portion to the duplex conveying path;
a reading unit configured to read an image formed on the recording material;
a third conveying path configured to guide the recording material reversed by the reversing portion to the reading unit; and
a fourth conveying path configured to guide the recording material that has passed through the reading unit to the duplex conveying path,
wherein a front and back orientation of the recording material coming from the reversing portion and passing through the third conveying path, the reading unit, the fourth conveying path, and the duplex conveying path is the same as a front and back orientation of the recording material coming from the reversing portion and passing through the second conveying path and the duplex conveying path, the front and back orientation being an orientation of a front surface on which an image is formed first and a back surface opposite the front surface; and
the second conveying path is disposed between the reading unit and the fixing unit.

10. The image forming apparatus according to claim 9,
wherein the fixing unit includes a first rotary member configured to come into contact with the unfixed image on the recording material and a second rotary member configured to form a fixing nip with the first rotary member to convey the recording material therebetween; and
the reading unit is disposed to face one of two surfaces of the recording material reversed by the reversing portion, the one being a surface that has more recently come into contact with the first rotary member.

11. An image forming apparatus comprising:
an image forming unit configured to form an unfixed image on a recording material;
a fixing unit configured to fix the unfixed image on the recording material;
a discharge reversing portion configured to be able to selectively discharge the recording material having the fixed image thereon out of the image forming apparatus and reverse the recording material in such a manner that instead of a leading edge, a trailing edge of the recording material that has passed through the fixing unit is conveyed;
a duplex conveying path configured to guide the recording material reversed by the discharge reversing portion to the image forming unit again;
a first conveying path configured to guide the recording material from the fixing unit to the discharge reversing portion;
a second conveying path configured to guide the recording material reversed by the discharge reversing portion to the duplex conveying path;
a reading unit configured to read an image formed on the recording material;
a third conveying path configured to guide the recording material reversed by the discharge reversing portion to the reading unit; and
a fourth conveying path configured to guide the recording material that has passed through the reading unit to the duplex conveying path,
wherein a front and back orientation of the recording material coming from the discharge reversing portion and passing through the third conveying path, the reading unit, the fourth conveying path, and the duplex conveying path is the same as a front and back orientation of the recording material coming from the discharge reversing portion and passing through the second conveying path and the duplex conveying path, the front and back orientation being an orientation of a front surface on which an image is formed first and a back surface opposite the front surface; and
the second conveying path is disposed between the reading unit and the fixing unit.

12. The image forming apparatus according to claim 11,
wherein the fixing unit includes a first rotary member configured to come into contact with the unfixed image on the recording material and a second rotary member configured to form a fixing nip with the first rotary member to convey the recording material therebetween; and
the reading unit is disposed to face one of two surfaces of the recording material reversed by the discharge reversing portion, the one being a surface that has more recently come into contact with the first rotary member.

13. The image forming apparatus according to claim 9, wherein when reading an image on a recording material, the image forming apparatus conveys the recording material through the third conveying path, the reading unit, and the fourth conveying path to the duplex conveying path, whereas when not reading an image on a recording material, the image forming apparatus conveys the recording material through the second conveying path to the duplex conveying path.
